(19) United States
(12) Patent Application Publication
(10) Pub. No.: US 2026/0220823 A1
(43) Pub. Date: Jul. 30, 2026

(54) IMAGE ENCODING METHOD, IMAGE ENCODING DEVICE, IMAGE DECODING METHOD, AND IMAGE DECODING DEVICE

(71) Applicant: Sony Group Corporation, Tokyo (JP)

(72) Inventor: Keisuke CHIDA, Tokyo (JP)

(73) Assignee: Sony Group Corporation, Tokyo (JP)

(21) Appl. No.: 19/146,767

(22) PCT Filed: Jan. 29, 2024
(86) PCT No.: PCT/JP2024/002561

§ 371 Date: Jul. 9, 2025

(30) Foreign Application Priority Data
Feb. 15, 2023 (JP) 2023-021346

(51) Int. Cl. G06T 9/00; G06N 3/045; G06T 3/4046; G06T 3/4053

(52) U.S. Cl. CPC G06T 9/002; G06N 3/045; G06T 3/4046; G06T 3/4053

(57) ABSTRACT

There is provided an image encoding method, an image encoding device, an image decoding method, and an image decoding device capable of enhancing image quality of an image accompanied by deterioration due to compression encoding at a lower cost. The image encoding method includes: acquiring encoded data by compressing and encoding an original image; acquiring a decoded image by decoding the encoded data; generating a first processed image by applying a first learned image processing model and a second learned image processing model learned in advance by using a generator and a discriminator to the decoded image at a first ratio; generating a second processed image by applying the first learned image processing model and the second learned image processing model to the decoded image at a second ratio; and generating control instruction data indicating an optimum ratio between the first learned image processing model and the second learned image processing model with respect to the original image on the basis of the discriminator, the first processed image, and the second processed image.

### TECHNICAL FIELD

The present disclosure relates to an image encoding method, an image encoding device, an image decoding method, and an image decoding device, and particularly relates to an image encoding method, an image encoding device, an image decoding method, and an image decoding device capable of enhancing image quality of an image accompanied by deterioration due to compression encoding at a lower cost.

### BACKGROUND ART

Since the original image of the distribution video content has high image quality but has a large data amount, it is common to distribute the original image after compressing and encoding the original image and perform decoding on the reception side. There is a system that compensates for image quality deterioration associated with transmission of distribution video content by image quality enhancement processing on a reception side (for example, see Patent Document 1). As the image quality enhancement processing, even in the super-resolution (DNN super-resolution) using the deep neural network (DNN), the obtained processing result is closer to the quality of the distribution video content before the compression encoding by using the subjective norm processing with higher image quality, and comfortable viewing becomes possible.

### CITATION LIST

### Patent Document

Patent Document 1: Japanese Patent Application Laid-Open No. 2013-38771

### SUMMARY OF THE INVENTION

### Problems to be Solved by the Invention

However, since the subjective norm processing is a generative model and may generate a signal that does not actually exist at the current technical level, there is a risk of causing degradation in image quality when the processing result is used as it is. In order to suppress degradation in image quality, for example, mixing with processing results of different image quality enhancement processing is assumed. However, in order to obtain an optimum mixing ratio, much labor and time are required, and cost is large. Therefore, there has been a demand for a technique for enhancing image quality of an image accompanied by deterioration due to compression encoding at a lower cost.

The present disclosure has been made in view of such a situation, and an object of the present disclosure is to enhance image quality of an image accompanied by deterioration due to compression encoding at a lower cost.

### Solutions to Problems

An image encoding method according to one aspect of the present disclosure is an image encoding method including: acquiring encoded data by compressing and encoding an original image; acquiring a decoded image by decoding the encoded data; generating a first processed image by applying a first learned image processing model and a second learned image processing model different from the first learned image processing model learned in advance by using a generator and a discriminator to the decoded image at a first ratio; generating a second processed image by applying the first learned image processing model and the second learned image processing model to the decoded image at a second ratio different from the first ratio; and generating control instruction data indicating an optimum ratio between the first learned image processing model and the second learned image processing model with respect to the original image on the basis of the discriminator, the first processed image, and the second processed image.

An image encoding device according to one aspect of the present disclosure is an image encoding device including: an encoding unit that acquires encoded data by compressing and encoding an original image; a decoding unit that obtains a decoded image by decoding the encoded data; and a generation unit that generates control instruction data indicating an optimum ratio between a first learned image processing model and a second learned image processing model different from the first learned image processing model learned in advance using a generator and a discriminator with respect to the original image, in which the generation unit is configured to: generate a first processed image by applying the first learned image processing model and the second learned image processing model to the decoded image at a first ratio; generate a second processed image by applying the first learned image processing model and the second learned image processing model to the decoded image at a second ratio different from the first ratio; and generate the control instruction data on the basis of the discriminator, the first processed image, and the second processed image.

In the image encoding method and the image encoding device according to one aspect of the present disclosure, encoded data is acquired by compressing and encoding an original image, a decoded image is acquired by decoding the encoded data, a first learned image processing model and a second learned image processing model different from the first learned image processing model learned in advance using a generator and a discriminator are applied to the decoded image at a first ratio to generate a first processed image, the first learned image processing model and the second learned image processing model are applied to the decoded image at a second ratio different from the first ratio to generate a second processed image, and control instruction data indicating an optimum ratio between the first learned image processing model and the second learned image processing model with respect to the original image is generated on the basis of the discriminator, the first processed image, and the second processed image.

An image decoding method according to one aspect of the present disclosure is an image decoding method including: acquiring a decoded image by decoding encoded data obtained by compressing and encoding an original image; generating a first generated image by applying a first learned image processing model to the decoded image; generating a second generated image by applying a second learned image processing model different from the first learned image processing model learned in advance using a generator and a discriminator to the decoded image; acquiring control instruction data indicating an optimum ratio between the first learned image processing model and the second learned image processing model with respect to the original image; and mixing the first generated image and the second generated image on the basis of the control instruction data, in which the optimum ratio is a ratio based on the discriminator, the first processed image, and the second processed image, the first processed image is generated by applying the first learned image processing model and the second learned image processing model to the decoded image at a first ratio, and the second processed image is generated by applying the first learned image processing model and the second learned image processing model to the decoded image at a second ratio different from the first ratio.

An image decoding device according to one aspect of the present disclosure is an image decoding device including: a decoding unit that acquires a decoded image by decoding encoded data obtained by compressing and encoding an original image; a first processing unit that generates a first generated image by applying a first learned image processing model to the decoded image; a second processing unit that generates a second generated image by applying a second learned image processing model different from the first learned image processing model learned in advance using a generator and a discriminator to the decoded image; an acquisition unit that acquires control instruction data indicating an optimum ratio between the first learned image processing model and the second learned image processing model with respect to the original image; and a mixing unit that mixes the first generated image and the second generated image on the basis of the control instruction data, in which the optimum ratio is a ratio based on the discriminator, the first processed image, and the second processed image, the first processed image is generated by applying the first learned image processing model and the second learned image processing model to the decoded image at a first ratio, and the second processed image is generated by applying the first learned image processing model and the second learned image processing model to the decoded image at a second ratio different from the first ratio.

In the image decoding method and the image decoding device according to one aspect of the present disclosure, a decoded image is acquired by decoding encoded data obtained by compressing and encoding an original image, a first generated image is generated by applying a first learned image processing model to the decoded image, a second generated image is generated by applying a second learned image processing model different from the first learned image processing model learned in advance using a generator and a discriminator to the decoded image, control instruction data indicating an optimum ratio between the first learned image processing model and the second learned image processing model with respect to the original image is acquired, and the first generated image and the second generated image are mixed on the basis of the control instruction data. Further, the optimum ratio is a ratio based on the discriminator, the first processed image, and the second processed image, the first processed image is generated by applying the first learned image processing model and the second learned image processing model to the decoded image at a first ratio, and the second processed image is generated by applying the first learned image processing model and the second learned image processing model to the decoded image at a second ratio different from the first ratio.

Note that the image encoding device and the image decoding device according to one aspect of the present disclosure may be independent devices, or may be internal blocks constituting one device.

### BRIEF DESCRIPTION OF DRAWINGS

FIG. 1 is a diagram for explaining a basic configuration of image quality enhancement of distribution video content.

FIG. 2 is a diagram for explaining a learning method of DNN super-resolution NW.

FIG. 3 is a block diagram illustrating another configuration of image quality enhancement of the distribution video content.

FIG. 4 is a block diagram illustrating a configuration when subjective norm processing is used in the system configuration of FIG. 3.

FIG. 5 is a diagram for explaining a method of generating control instruction data when image quality evaluation is performed by a user in pre-simulation.

FIG. 6 is a diagram illustrating a method of region division of an image.

FIG. 7 is a block diagram illustrating a configuration example of a system to which the present disclosure is applied.

FIG. 8 is a diagram for explaining a learning method of error norm processing.

FIG. 9 is a diagram for explaining a method of learning subjective norm processing.

FIG. 10 is a diagram for explaining details of a GAN learning method of subjective norm processing.

FIG. 11 is a diagram for explaining a method of generating control instruction data to which the present disclosure is applied.

FIG. 12 is a diagram illustrating an example of a mixing ratio at a boundary portion between a divided region and an adjacent region.

FIG. 13 is a flowchart for explaining a flow of control instruction data generation processing.

FIG. 14 is a flowchart for explaining a flow of image quality enhancement processing using control instruction data.

FIG. 15 is a block diagram illustrating another configuration example of a system to which the present disclosure is applied.

FIG. 16 is a diagram for explaining another method of generating control instruction data to which the present disclosure is applied.

FIG. 17 is a diagram for explaining a basic configuration of image quality enhancement of distribution video content when a bit rate fluctuates.

FIG. 18 is a diagram for explaining processing at the time of learning when a bit rate fluctuates.

FIG. 19 is a diagram for explaining image quality enhancement processing when a bit rate fluctuates.

FIG. 20 is a diagram for explaining another method of generating control instruction data to which the present disclosure is applied.

FIG. 21 is a diagram illustrating a method of region division of an image.

FIG. 22 is a flowchart for explaining a flow of control instruction data generation processing.

FIG. 23 is a diagram for explaining an example of a UI of a game content.

FIG. 24 is a block diagram illustrating a configuration example of a computer.

### MODE FOR CARRYING OUT THE INVENTION

### <Configuration of Image Quality Enhancement>

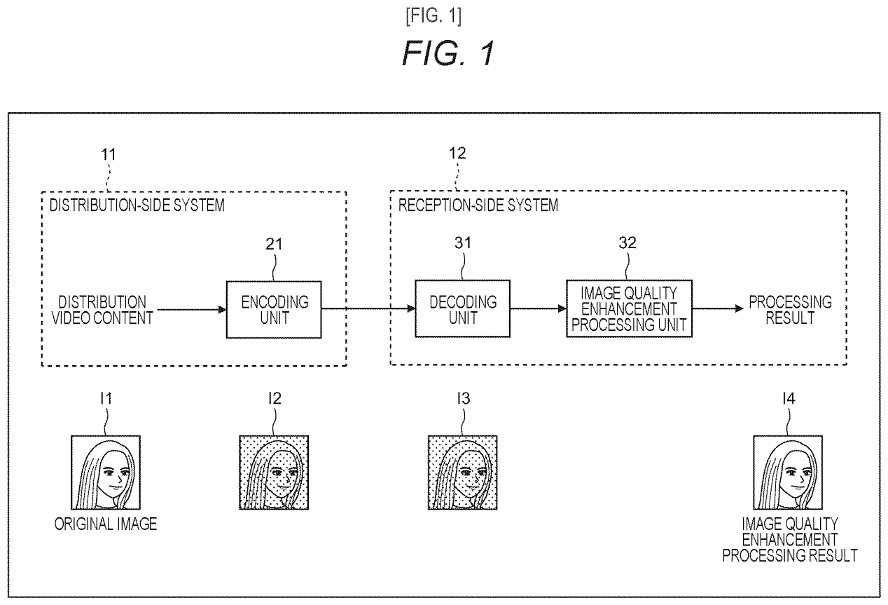

FIG. 1 is a diagram for explaining a basic configuration of image quality enhancement of distribution video content.

In FIG. 1, a distribution-side system 11 compresses and encodes the distribution video content by an encoding unit 21, and distributes the distribution video content via a transmission path such as the Internet. A reception-side system 12 receives the compressed and encoded distribution video content distributed from the distribution-side system 11 via the transmission path, and decodes the compressed and encoded distribution video content by the decoding unit 31. The reception-side system 12 performs image quality enhancement processing on the decoded distribution video content by the image quality enhancement processing unit 32, and outputs a processing result.

Although the original image of the distribution video content has high image quality, since the data amount is large, in the case of a service that distributes a large number of pieces of data at a time, it is not always possible to distribute the original image due to restrictions on the amount of distributable data or the like. Therefore, in the distribution-side system 11, the encoding unit 21 compresses and encodes the original image (encoding by the codec) to reduce the amount of data, and then distributes the original image. Meanwhile, in the reception-side system 12, the decoding unit 31 decodes the compressed and encoded original image (decoding by the codec).

In these processes, data of the original image is partially lost, and the image quality is degraded. Therefore, in the reception-side system 12, the image quality enhancement processing unit 32 performs the image quality enhancement processing after decoding to compensate for the image quality degradation. In FIG. 1, the image quality of the compressed and encoded image I2 and the decoded image I3 is degraded, but by performing the image quality enhancement processing after decoding, the image I4 as a result of the image quality enhancement processing becomes an image close to the image quality of the original image I1. There are various types of compression codecs, and there is a case where compression is performed by specifying a data amount per second (compression bit rate), but image quality after compression varies depending on the compression codec and the compression bit rate. For example, compression codecs include MPEG2, advanced video coding (AVC), high efficiency video coding (HEVC), and the like.

In the image quality enhancement processing by the image quality enhancement processing unit 32, processing such as super-resolution (hereinafter, referred to as DUN super-resolution) using a deep neural network (DNN) is performed. Since the DNN super-resolution is learning type processing, learning is performed using a pair of an image (decoded image) decoded after compression encoding and an original image before the distribution video content is viewed by the reception-side system 12, and the network (NW) of the learning result is held in advance by the reception-side system 12.

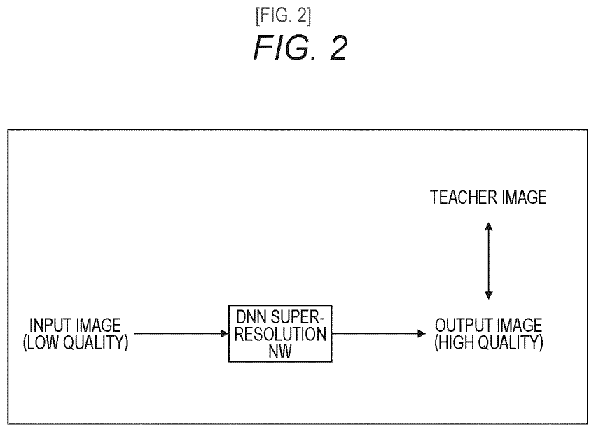

For example, as illustrated in FIG. 2, when a low quality input image (decoded image) is input to the DNN super-resolution NW and a high quality output image is output, learning of the DNN super-resolution NW is performed such that the image quality of the output image is the same as the image quality of the teacher image (original image). Note that the network (NW) of the learning result may be transmitted to the reception-side system 12 for each distribution video content. That is, when the distribution video content is viewed in the reception-side system 12, the real-time learning is not performed.

As processing of the DNN super-resolution, there are error norm processing and subjective norm processing. In the error norm processing and the subjective norm processing, processing using a learned network (NW) is performed.

The error norm processing (PSNR-Based Signal Processing) is processing using a network (NW) that performs learning so as to minimize an error between a real image (a teacher image at the time of learning) and an image of a processing result. In the present disclosure, the error is an absolute difference sum of values of all pixels at the same position in the correct image and the processing result image. When the image has a plurality of channels of color information (for example, 3 ch of RGB), an error is obtained for each channel, and then an average thereof is obtained. Since the absolute difference sum and the peak signal-to-noise ratio (PSNR) are essentially the same error index, they are often referred to as PSNR-Based.

The subjective norm processing (perceptual-Based (or Perceptual-Oriented) Signal Processing) is processing using a network (NW) that has performed learning so that the perceptual quality of the image of the processing result is the highest. An image with high perceptual quality is an image that humans feel as being clear and of high image quality when viewed. A high perceptual quality image does not necessarily match a real image. Although details will be described later, the present disclosure is realized by a generative model using learning of a Generative Adversarial Network (GAN). The generative model is a processing model that learns a probability distribution for generating an image and generates new data.

Comparison between the error norm processing and the subjective norm processing has the following characteristics. That is, since the error norm processing minimizes the errors of all the images of the image data used at the time of learning, the processing using the learning result is an average result. Therefore, the processing result looks blurred as an appearance, but does not deviate greatly from the true correct image, and does not have a disadvantage as the subjective norm processing described later. Meanwhile, since the subjective norm processing outputs one sample having a high probability as a generative model, the output is clearer than the error norm processing, and there is a possibility that the image quality can be further enhanced. However, as a disadvantage, whether the output result is really correct is not ensured, and there is no index capable of accurately measuring whether the image quality is really high at the present time. The subjective norm processing does not necessarily have the minimum error and is not close to the correct answer, but is established as the image quality enhancement processing as long as the image can be seen clearly.

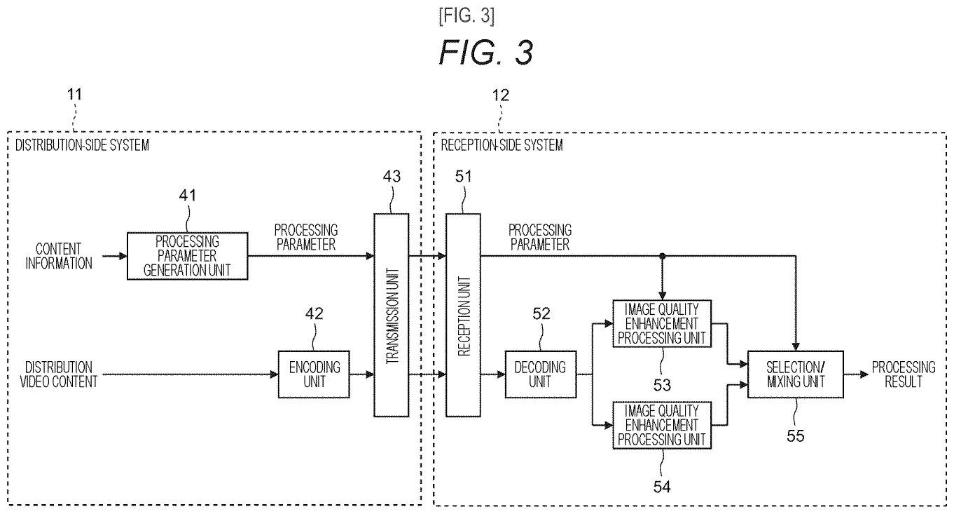

FIG. 3 is a block diagram illustrating another configuration of image quality enhancement of the distribution video content. In FIG. 3, the distribution-side system 11 includes a processing parameter generation unit 41 that generates a processing parameter on the basis of content information regarding the distribution video content, an encoding unit 42 that compresses and encodes the distribution video content, and a transmission unit 43 that transmits the processing parameter and the distribution video content. The distribution-side system 11 can prepare a processing parameter (a type of codec or the like) to be set with the distribution video content and distribute the processing parameter to the reception-side system 12.

In FIG. 3, the reception-side system 12 includes a reception unit 51 that receives the processing parameter and the distribution video content distributed from the distribution-side system 11, a decoding unit 52 that decodes the received distribution video content, an image quality enhancement processing unit 53 and an image quality enhancement processing unit 54 that execute image quality enhancement processing on the decoded distribution video content, and a selection/mixing unit 55 that selects or mixes processing results of the image quality enhancement processing unit 53 and the image quality enhancement processing unit 54 and outputs the processing results.

In FIG. 3, in the reception-side system 12, in the image quality enhancement processing by the image quality enhancement processing unit 53 and the image quality enhancement processing unit 54, the image quality enhancement processing can be switched by performing adjustment according to the processing parameter. As a method of generating the processing parameter, a method in which a user (human) such as a system builder manually sets an optimum parameter for each distribution video content is assumed, but a large amount of labor and time are required.

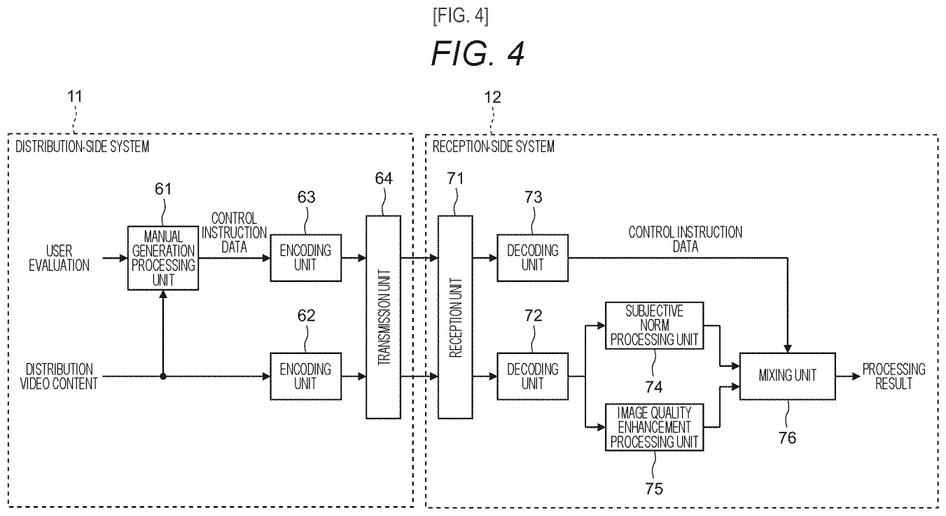

FIG. 4 is a block diagram illustrating a configuration when subjective norm processing is used in the system configuration of FIG. 3. In FIG. 4, the distribution-side system 11 includes a manual generation processing unit 61 that manually generates the control instruction data according to the image quality evaluation by the user (human) such as the system builder, an encoding unit 62 that compresses and encodes the distribution video content, an encoding unit 63 that compresses and encodes the control instruction data, and a transmission unit 64 that transmits the distribution video content and the control instruction data. The distribution-side system 11 can prepare control instruction data indicating a mixing ratio of the subjective norm processing and the image quality enhancement processing different from the subjective norm processing, and distribute the control instruction data to the reception-side system 12 together with the distribution video content.

In FIG. 4, the reception-side system 12 includes a reception unit 71 that receives the distribution video content and the control instruction data distributed from the distribution-side system 11, a decoding unit 72 that decodes the received distribution video content, a decoding unit 73 that decodes the received control instruction data, a subjective norm processing unit 74 that executes subjective norm processing on the decoded distribution video content, an image quality enhancement processing unit 75 that executes image quality enhancement processing different from the subjective norm processing on the decoded distribution video content, and a mixing unit 76 that mixes the processing results of the subjective norm processing unit 74 and the image quality enhancement processing unit 75 and outputs the processing result.

In FIG. 4, in the reception-side system 12, the mixing unit 76 mixes the processing result from the subjective norm processing unit 74 and the processing result from the image quality enhancement processing unit 75 according to the control instruction data, so that it is possible to obtain a better image quality processing result and to suppress quality degradation. That is, although the subjective norm processing has very high image quality enhancement performance, there is a case where a person feels uncomfortable about a part of the processing result. Therefore, it is assumed that such a problem is improved by switching and mixing a part of the subjective norm processing to another image quality enhancement processing that does not cause discomfort caused by the subjective norm processing.

In FIG. 4, since there is an original image of the distribution video content before compression encoding in the distribution-side system 11, it is possible to more accurately extract the portion of the quality degradation by simulating the signal processing of the entire system and comparing the subjective processing result with the original image. Furthermore, if it is possible to confirm whether quality degradation cannot be reduced by mixing (or replacing) the processing result of another image quality enhancement processing with respect to the extracted portion by simulation and to acquire the optimum mixing ratio (or whether or not to replace it), it is possible to distribute the control instruction data indicating the optimum mixing ratio simultaneously with the distribution video content. In the reception-side system 12, the processing results of the subjective norm processing unit 74 and the image quality enhancement processing unit 75 are mixed (or replaced) according to the control instruction data generated by the pre-simulation of the distribution-side system 11, so that a higher-quality processing result can be obtained.

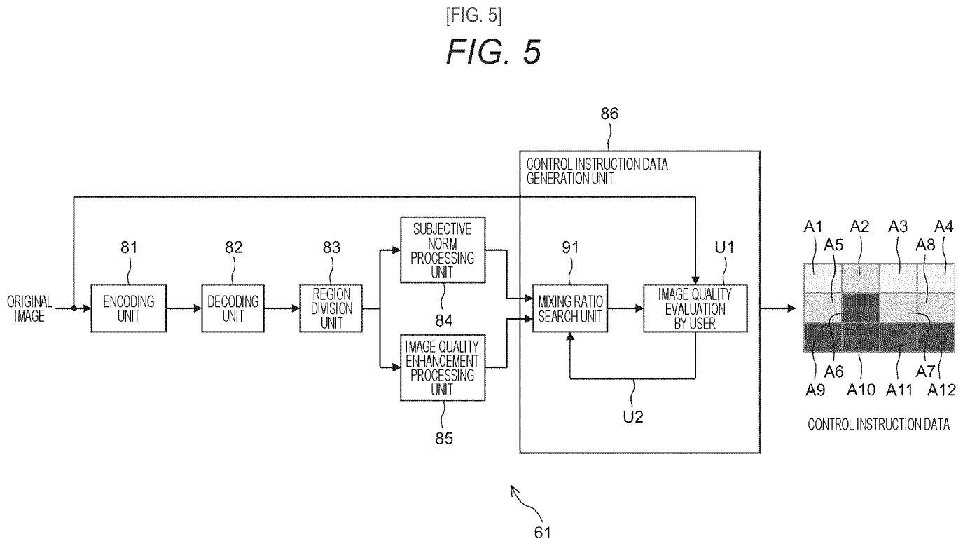

FIG. 5 is a diagram for explaining a method of generating control instruction data when image quality evaluation is performed by a user in pre-simulation. In FIG. 5, the manual generation processing unit 61 includes an encoding unit 81, a decoding unit 82, a region division unit 83, a subjective norm processing unit 84, an image quality enhancement processing unit 85, and a control instruction data generation unit 86 in order to generate control instruction data by simulating in advance the signal processing of the encoding unit 62, the decoding unit 72, the subjective norm processing unit 74, the image quality enhancement processing unit 75, and the mixing unit 76 in FIG. 4.

The encoding unit 81 compresses and encodes an original image of the distribution video content input thereto, and supplies encoded data obtained as a result to the decoding unit 82. The decoding unit 82 decodes the encoded data from the encoding unit 81, and supplies a decoded image of the distribution video content obtained as a result to the region division unit 83.

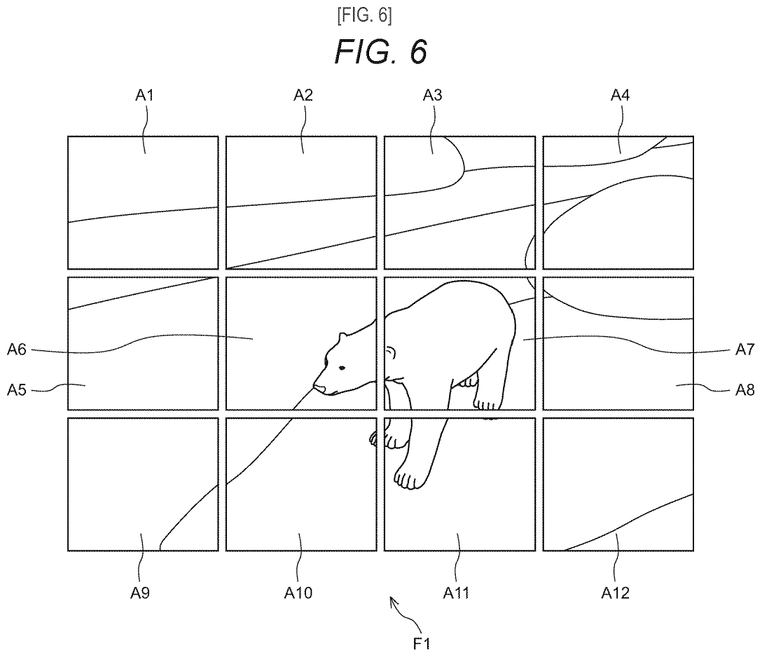

The region division unit 83 divides the decoded image from the decoding unit 82 into predetermined regions, and supplies the divided decoded image to the subjective norm processing unit 84 and the image quality enhancement processing unit 85. FIG. 6 is a diagram illustrating a method of region division of an image. In FIG. 6, image F1 of the decoded image is divided into 12 rectangular regions A1 to A12 of 3×4 in length and width. It is possible to divide the image in units that are easy for the user who performs the image quality evaluation to evaluate for each part. In FIG. 6, the region is divided into rectangular regions, but the region is not necessarily rectangular, and may be divided into an arbitrary shape. Note that a segmentation method may be separately used for image division.

The subjective norm processing unit 84 executes subjective norm processing on the divided decoded image from the region division unit 83, and supplies an image of a result of the subjective norm processing obtained as a result to the control instruction data generation unit 86. The image quality enhancement processing unit 85 executes image quality enhancement processing different from the subjective norm processing on the divided decoded image from the region division unit 83, and supplies an image of another image quality enhancement processing result obtained as a result to the control instruction data generation unit 86.

In the control instruction data generation unit 86, a mixing ratio search unit 91 mixes the image of the subjective norm processing result with an image of another image quality enhancement processing result in order until the value of the mixing ratio changes from 0 to 1.0 (0% to 100%). At this time, by presenting the mixed image and the original image according to the mixing ratio, the user compares the mixed image with the original image to evaluate the image quality, and determines the mixing ratio at which the image quality evaluation result is maximized for each divided region of the image (U1 and U2 in the drawing). As described above, the mixing ratio that maximizes the image quality evaluation result visually determined by the user is the control instruction data. The control instruction data is obtained in time series according to image quality evaluation by the user. In FIG. 5, divided regions A1 to A12 of the control instruction data (control instruction map) correspond to the regions (regions A1 to A12 in FIG. 6) of the decoded image divided by the region division unit 83, and the mixing ratio determined for each of the divided regions A1 to A12 is represented by shading.

In this way, by generating the control instruction data by the pre-simulation and distributing the control instruction data from the distribution-side system 11 to the reception-side system 12, the reception-side system 12 can obtain a higher quality processing result by mixing the image of the subjective norm processing result and the image of another image quality enhancement processing result according to the control instruction data. However, when the method for generating the control instruction data in FIG. 5 is used, the evaluation of the user (human) is necessary, and the control instruction data varies in each distribution video content and compression bit rate, so that much labor and time are necessary. It is difficult to generate the control instruction data by the generation method illustrated in FIG. 5. Therefore, there is a demand for a technique for generating control instruction data indicating an optimum mixing ratio between subjective norm processing and another image quality enhancement processing at a lower cost.

### <System Configuration of Present Disclosure>

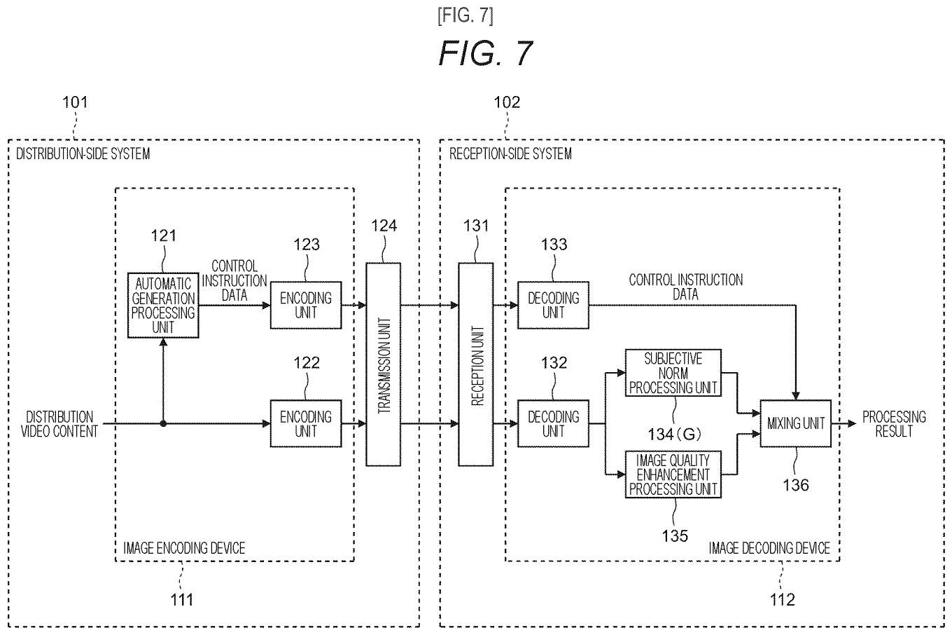

FIG. 7 is a block diagram illustrating a configuration example of a system to which the present disclosure is applied. In FIG. 7, the distribution-side system 101 includes an automatic generation processing unit 121, an encoding unit 122, an encoding unit 123, and a transmission unit 124. The reception-side system 102 includes a reception unit 131, a decoding unit 132, a decoding unit 133, a subjective norm processing unit 134, an image quality enhancement processing unit 135, and a mixing unit 136. The image encoding device 111 includes an automatic generation processing unit 121, an encoding unit 122, and an encoding unit 123. The image decoding device 22 includes a decoding unit 132, a decoding unit 133, a subjective norm processing unit 134, an image quality enhancement processing unit 135, and a mixing unit 136.

Using the original image (image before compression encoding) of the distribution video content input thereto, the automatic generation processing unit 121 automatically obtains an optimum mixing ratio between the subjective norm processing and another image quality enhancement processing for the original image, thereby generating control instruction data. In the automatic generation processing unit 121, a discriminator used at the time of GAN learning of the subjective norm processing is used as an index for extracting a quality degradation portion. Although it is difficult to use this type of discriminator as a general-purpose index for any subjective norm processing result due to low realistic discrimination accuracy, the discriminator can be used as a unique index only for a pair of the subjective norm processing of the reception-side system 102 and at the time of learning by the GAN learning mechanism.

The encoding unit 122 compresses and encodes the distribution video content input thereto according to a predetermined encoding scheme, and supplies the distribution video content to the transmission unit 124. The encoding unit 123 compresses and encodes the control instruction data from the automatic generation processing unit 121 according to a predetermined encoding scheme, and supplies the control instruction data to the transmission unit 124. The transmission unit 124 transmits the compressed and encoded distribution video content from the encoding unit 122 and the compressed and encoded control instruction data from the encoding unit 123 via a transmission path according to a predetermined communication scheme.

As a result, the distribution-side system 101 distributes the stream of the distribution video content and distributes the control instruction data to the reception-side system 102. The control instruction data is transmitted in synchronization with the target image frame in the distribution video content. For example, the control instruction data can be distributed using side information defined by a standard such as MPEG.

The reception unit 131 receives the distribution video content and the control instruction data transmitted from the distribution-side system 101 via the transmission path according to a predetermined communication scheme. The reception unit 131 supplies the received distribution video content to the decoding unit 132, and supplies the received control instruction data to the decoding unit 133. The decoding unit 132 decodes the distribution video content from the reception unit 131 according to a predetermined decoding method, and supplies the decoded video content to the subjective norm processing unit 134 and the image quality enhancement processing unit 135. The decoding unit 133 decodes the control instruction data from the reception unit 131 according to a predetermined decoding method, and supplies the control instruction data to the mixing unit 136.

The subjective norm processing unit 134 executes subjective norm processing on the distribution video content (decoded image) from the decoding unit 132, and supplies a result of the subjective norm processing obtained as a result to the mixing unit 136. The image quality enhancement processing unit 135 executes image quality enhancement processing (for example, error norm processing) different from the subjective norm processing result on the distribution video content (decoded image) from the decoding unit 132, and supplies the image quality enhancement processing result obtained as a result to the mixing unit 136. In accordance with the control instruction data from the decoding unit 133, the mixing unit 136 mixes the image of the subjective norm processing result from the subjective norm processing unit 134 and the image of the image quality enhancement processing result from the image quality enhancement processing unit 135, and outputs an image of a final processing result obtained as a result.

Here, the subjective norm processing by the subjective norm processing unit 134 and another image quality enhancement processing (for example, error norm processing) by the image quality enhancement processing unit 135 are performed by using a learned network (NW). It can also be said that the learned network (NW) is a learned image processing model.

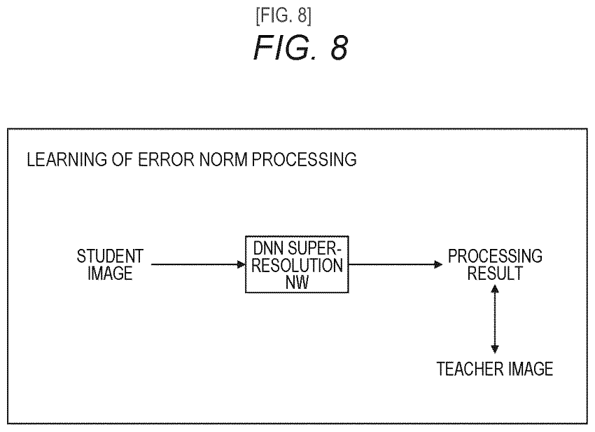

FIG. 8 is a diagram for explaining a learning method of the error norm processing. In FIG. 8, in the learning of the error norm processing, a pair of a student image and a teacher image is used as learning data, and the network (NW) is learned such that the sum of difference absolute values for each pixel between the image of the processing result output from the DNN super-resolution NW to which the student image is input and the teacher image is reduced. The DNN super-resolution NW obtained by such learning is used in another image quality enhancement processing by the image quality enhancement processing unit 135 (FIG. 7) of the reception-side system 102, and an image (generated image) having a higher image quality than the input decoded image is generated.

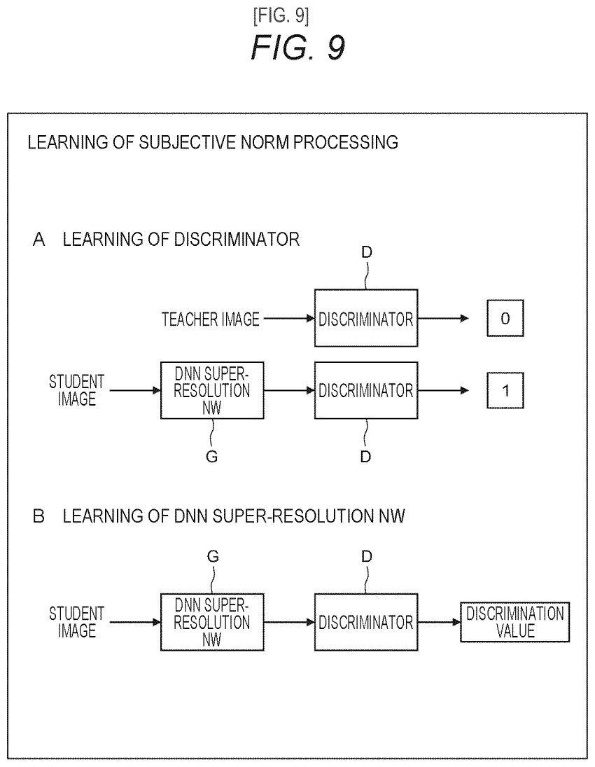

FIG. 9 is a diagram for explaining a method of learning subjective norm processing. In the learning of the subjective norm processing, learning of the GAN is performed. A of FIG. 9 illustrates learning of a discriminator (D) including a DNN. At the time of learning of the discriminator (D), the DNN super-resolution NW (G) is fixed. In the GAN learning, the DNN super-resolution NW is also called a generator (G). In A of FIG. 9, the discriminator (D) performs learning so as to output 0 (real) when the teacher image is input and output 1 (false) when the image of the processing result from the DNN super-resolution NW (G) to which the student image is input to discriminate the teacher image from the image of the processing result.

B of FIG. 9 illustrates learning of the DNN super-resolution NW. At the time of learning the DNN super-resolution NW (G), the discriminator (D) is fixed. In B of FIG. 9, when the student image is input, the DNN super-resolution NW (G) outputs the image of the processing result to the discriminator (D). The discriminator (D) discriminates the image of the processing result input from the DNN super-resolution NW and outputs a discrimination value. Here, the discriminator (D) learned in A of FIG. 9 outputs 1 with high probability when the processing result from the DNN super-resolution NW (G) is input, but the DNN super-resolution NW (G) learned in B of FIG. 9 performs learning so that the discriminator (D) outputs 0 as a processing result (an image that is mistaken for a teacher image). By such learning of the DNN super-resolution NW (G), the discriminator (D) outputs 0 when the processing result from the DNN super-resolution NW (G) is input.

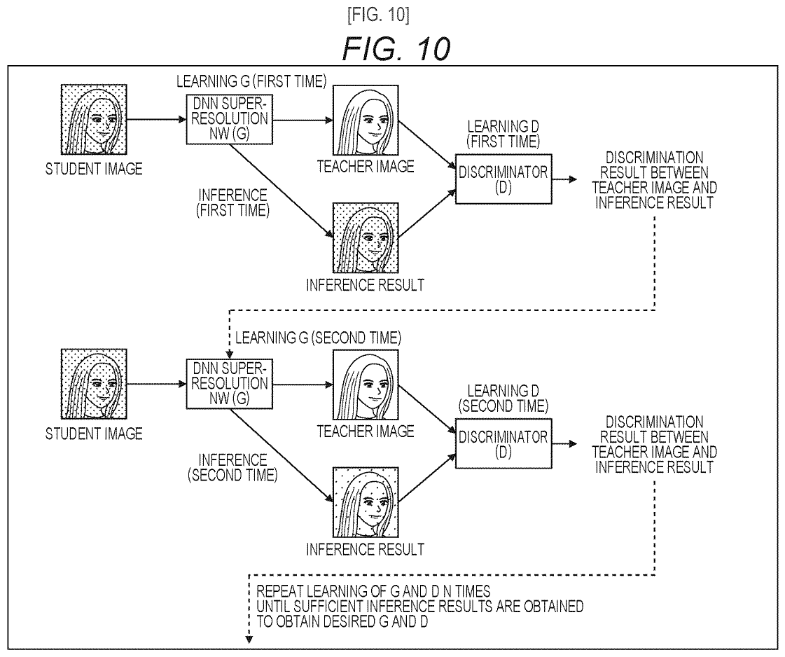

Thereafter, by alternately repeating the learning of the discriminator (D) illustrated in A of FIG. 9 and the learning of the DUN super-resolution NW (G) illustrated in B of FIG. 9, the discriminator (D) and the DNN super-resolution NW (G) learn while enhancing each other. FIG. 10 is a diagram for explaining details of a GAN learning method of subjective norm processing.

In FIG. 10, in the first learning of the DUN super-resolution NW (G), learning is performed such that the discriminator (D) discriminates the image of the processing result of the DUN super-resolution NW (G) to which the student image is input as the teacher image. After the first learning of the DNN super-resolution NW (G) is completed, the first inference is performed by inputting the student image to the DNN super-resolution NW (G). In the first learning of the discriminator (D), the teacher image and the image of the first inference result are input to the discriminator (D), and learning is performed so that the teacher image and the image of the inference result can be discriminated.

In the second learning of the DNN super-resolution NW (G), learning is performed such that the discriminator (D) generates a new inference result in which the discriminator (D) hesitates to determine the teacher image and the image of the inference result using the discrimination result of the discriminator (D). After the learning of the second DNN super-resolution NW (G) is completed, the second inference is performed by inputting the student image to the DNN super-resolution NW (G). The inference result obtained by the second inference is an image different from the first inference result, and generally has a better image quality. In the second learning of the discriminator (D), the teacher image and the image of the second inference result are input to the discriminator (D), and learning is performed so that the teacher image and the image of the inference result can be discriminated.

Although only the first and second learnings are illustrated in FIG. 10, learning of the DNN super-resolution NW (G) and the discriminator (D) is similarly performed at the third and subsequent learnings. Then, the learning of the DNN super-resolution NW (G) and the discriminator (D) is repeated N times (N: an integer of 1 or more) until a sufficient inference result by the DNN super-resolution NW (G) is obtained, and a desired DNN super-resolution NW (G) and discriminator (D) can be obtained. Note that the image quality is not necessarily enhanced as the number of repetitions of learning increases, and there is an upper limit in the improvement effect due to the calculation scale of the DNN super-resolution NW, the characteristics of the learning data, and the like. Therefore, it is desirable to repeat learning according to the upper limit. The DUN super-resolution NW (G) obtained by the GAN learning is used in the subjective norm processing by the subjective norm processing unit 134 (FIG. 7) of the reception-side system 102 to generate an image (generated image) with higher image quality than the input decoded image.

Since the discriminator (D) finally obtained by performing such GAN learning can perform discrimination focusing on a difference from the teacher data (teacher image) specific to the inference result of the DNN super-resolution NW (G), it is possible to numerically output how close the inference result of the DUN super-resolution NW (G) paired at the time of learning is to the teacher data (it is possible to highly discriminate the difference from the teacher image). Note that, in the combination of the DNN super-resolution NW (G) and the discriminator (D) that are not paired at the time of learning, a state in which an error occurs between the inference result of the DUN super-resolution NW (G) and the teacher data (teacher image) is different, and thus the discriminator (D) cannot make a correct determination.

As described above, since the discriminator (D) performs discrimination in response to a portion where the processing result of the single DNN super-resolution NW (G) does not approach the teacher image, the discriminator (D) can be used as an index in a direction approaching the teacher image by switching control with another image quality enhancement processing. That is, the discriminator (D) is secondarily obtained at the time of GAN learning, and usually, only the learned DNN super-resolution NW (G) is used. However, in the present disclosure, the discriminator (D) uses both the learned DNN super-resolution NW (G) and the discriminator (D) by focusing on the fact that the discriminator (D) is capable of highly discriminating whether or not the processing result of the DNN super-resolution NW (G) paired at the time of GAN learning is close to the teacher image.

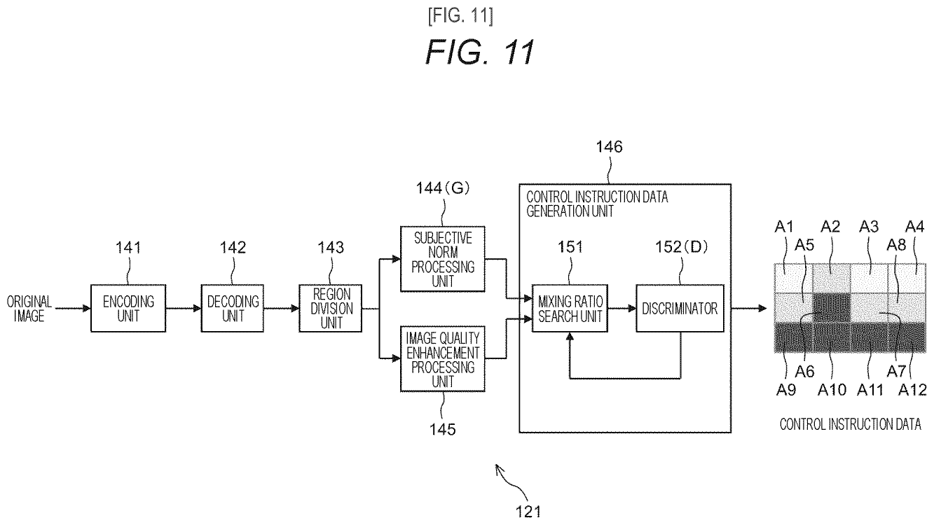

FIG. 11 is a diagram for explaining a method of generating control instruction data to which the present disclosure is applied. In FIG. 11, the automatic generation processing unit 121 includes an encoding unit 141, a decoding unit 142, a region division unit 143, a subjective norm processing unit 144, an image quality enhancement processing unit 145, and a control instruction data generation unit 146. In the control instruction data generation unit 146, the control instruction data generation unit 146 includes a mixing ratio search unit 151 and a discriminator 152. As described with reference to FIGS. 9 and 10, the subjective norm processing unit 144 (G) and the discriminator 152 (D) correspond to the DN super-resolution NW (G) and the discriminator (D) paired at the time of GAN learning.

The encoding unit 141 compresses and encodes an original image of the distribution video content input thereto, and supplies encoded data obtained as a result to the decoding unit 142. The decoding unit 142 decodes the encoded data from the encoding unit 141, and supplies a decoded image of the distribution video content (decoded Image) obtained as a result to the region division unit 143.

The region division unit 143 divides (the image frames of) the decoded image from the decoding unit 142 into predetermined regions, and supplies the divided decoded image to the subjective norm processing unit 144 and the image quality enhancement processing unit 145. Here, the region size is divided into region sizes that can be discriminated by a normal discriminator. Since the discriminator may have a filed image size that can be input to the network (NW) depending on the network (NW) configuration, the discriminator divides the image according to the image size that can be input to the discriminator 152 described later. Generally, the inputtable image size is often a rectangle, and in this example, a case where the image is divided into regions A1 to A12 is illustrated similarly to the case illustrated in FIG. 6 in order to facilitate the description.

The subjective norm processing unit 144 includes a DUN super-resolution NW (G) learned by learning of subjective norm processing (GAN learning). The subjective norm processing unit 144 executes subjective norm processing on the divided decoded image from the region division unit 143, and supplies an image of a result of the subjective norm processing obtained as a result to the control instruction data generation unit 146. The image quality enhancement processing unit 145 includes, for ex ample, the DNN super-resolution NW learned by learning of the error norm processing. The image quality enhancement processing unit 145 executes image quality enhancement processing (for example, error norm processing) different from the subjective norm processing on the divided decoded image from the region division unit 143, and supplies an image of another image quality enhancement processing result obtained as a result to the control instruction data generation unit 146.

The control instruction data generation unit 146 generates control instruction data indicating an optimum mixing ratio between the image of the subjective norm processing result from the subjective norm processing unit 144 and the image of the image quality enhancement processing result from the image quality enhancement processing unit 145 with respect to the original image of the distribution video content. The discriminator 152 includes a discriminator (D) paired with the DNN super-resolution NW (G) at the time of GAN learning. That is, the discriminator 152 is a unique discriminator (D) when GAN learning is performed on the DNN super-resolution NW (G) used in the subjective norm processing in the subjective norm processing unit 144.

In the control instruction data generation unit 146, the mixing ratio search unit 151 sequentially mixes the image of the subjective norm processing result with the image of another image quality enhancement processing result until the value of the mixing ratio becomes 0 to 1.0 and inputs the mixture to the discriminator 152, and obtains the ratio at which the value of the discrimination result of the discriminator 152 becomes minimum. That is, as the value of the discrimination result of the discriminator 152 is smaller, the discriminator 152 determines that the image is the original image. Therefore, the optimum mixing ratio is set to the ratio at which the value of the discrimination result is minimum. This mixing ratio is the control instruction data. The control instruction data is obtained in time series according to the input original image. In FIG. 11, the divided regions A1 to A12 of the control instruction data (control instruction map) correspond to the divided regions (for example, the regions A1 to A12 in FIG. 5) divided by the region division unit 143, and the mixing ratio automatically calculated for each of the divided regions A1 to A12 is represented by shading.

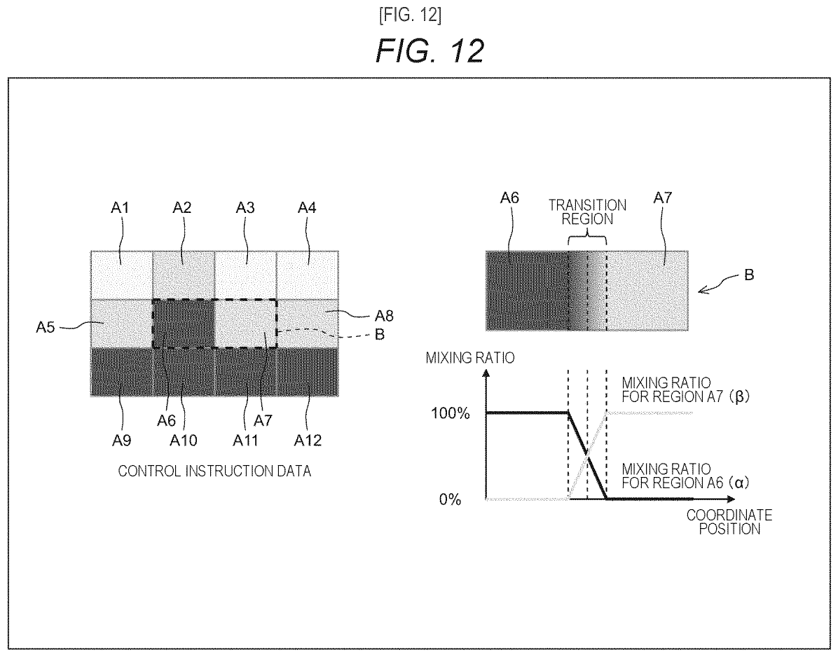

In FIG. 11, the optimum mixing ratio is obtained for each of the divided regions A1 to A12, but the processing boundary on the image may be made inconspicuous by continuously changing the optimum mixing ratio at the boundary portion with the adjacent region. FIG. 12 is a diagram illustrating an example of a mixing ratio at a boundary portion between the divided region and the adjacent region. In FIG. 12, focusing on the boundary portion between the divided regions A6 and A7 surrounded by the frame E of the broken line among the divided regions A1 to A12, the control instruction value of the transition region is expressed by the following Formula (1) with the boundary portion as the transition region.

Control instruction value of transition region=control instruction value of region A6×α+control instruction value of region A7×β (1)

However, in Formula (1), the relationship of α+β=1.0 is satisfied. FIG. 12 illustrates the relationship between the mixing ratio (α) of the region A6 and the mixing ratio (β) of the region A7 when the horizontal axis represents the coordinate position on the image and the vertical axis represents the mixing ratio. By providing the transition region at the boundary portion, the mixing ratio at the boundary portion can be continuously changed, so that the processing boundary on the image can be made inconspicuous.

Note that although FIG. 12 focuses on the boundary portion between the divided regions A6 and A7, the transition region can be similarly provided not only at the boundary in the left-right direction but also at the boundary in the up-down direction. For example, with respect to the divided region A6, transition regions can be provided in the divided regions A5 and A7 in the left-right direction and the divided regions A2 and A10 in the up-down direction. Furthermore, with respect to the divided region A6, transition regions may be provided in the divided regions A1, A3, A9, and A11 in the oblique direction.

### <Flow of Processing>

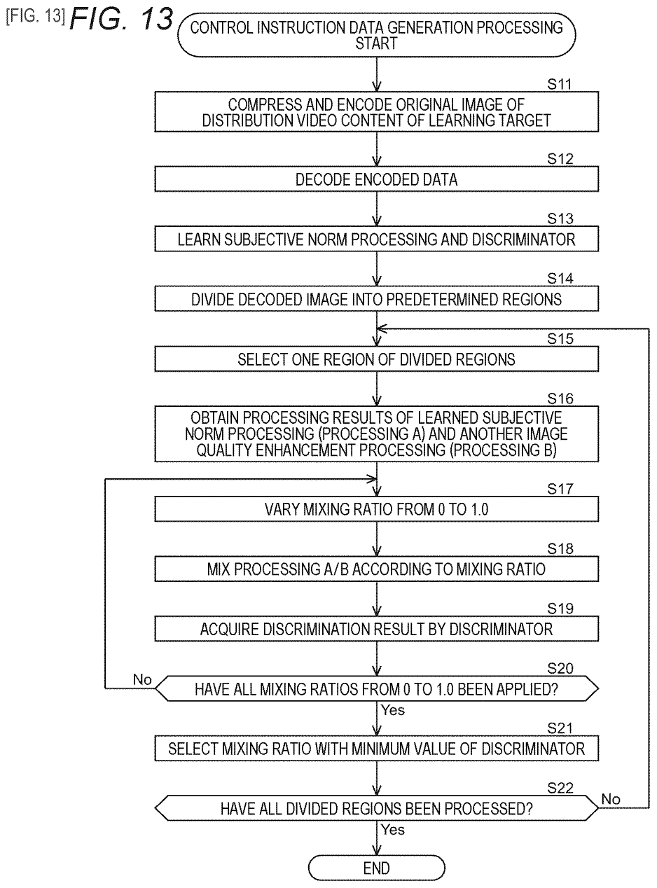

A flow of control instruction data generation processing will be described with reference to a flowchart of FIG. 13. In the distribution-side system 101, when the control instruction data generation processing is executed by the automatic generation processing unit 121, the distribution video content to be learned is determined, and the determined distribution video content is processed.

In step S11, the encoding unit 141 acquires encoded data by compressing and encoding an original image of the distribution video content as a learning target. In step 512, the decoding unit 142 acquires the decoded image of the distribution video content by decoding the encoded data.

In step S13, the subjective norm processing (the DUN super-resolution NW thereof) and the learning of the discriminator are performed. As described with reference to FIGS. 9 and 10, in the GAN learning of the subjective norm processing, learning of the discriminator (D) and learning of the DNN super-resolution NW (G) are repeated, so that a learning pair of the DNN super-resolution IW (G) and the discriminator (D) is obtained after completion of learning of the DNN super-resolution NW (G). At the time of generating the control instruction data, among the learning pairs, the DNN super-resolution NW (G) is used in the subjective norm processing by the subjective norm processing unit 144 (FIG. 11), and the discriminator (D) is used in the discriminator 152 (FIG. 11). Note that, as described with reference to FIG. 8, the DNN super-resolution NW obtained by learning of the error norm processing can be used in another image quality enhancement processing by the image quality enhancement processing unit 145 (FIG. 11) at the time of generating the control instruction data.

In step S14, the region division unit 143 divides the decoded image of the distribution video content into predetermined regions. For example, as illustrated in FIG. 6, image F1 of the decoded image is divided into rectangular regions A1 to A12, so that one of the divided regions is selected (S15).

In step S16, the subjective norm processing unit 144 executes subjective norm processing (processing A) by the learned DNN super-resolution NW (G) on the selected divided region to obtain a subjective norm processing result. In addition, in step S16, the image quality enhancement processing unit 145 executes another image quality enhancement processing (processing B) on the selected divided region to obtain the image quality enhancement processing result.

In step S17, the mixing ratio search unit 151 changes and applies the value of the mixing ratio between 0 to 0.1. In step S18, the mixing ratio search unit 151 mixes the image of the processing result of the subjective norm processing (processing A) and the image of the processing result of another image quality enhancement processing (processing B) with the applied mixing ratio. In step S19, the control instruction data generation unit 146 inputs the image (processed image) of the mixing processing result obtained by mixing the image of the subjective norm processing result and the image of the image quality enhancement processing result according to the applied mixing ratio to the discriminator 152, thereby acquiring the discrimination result by the discriminator 152 (the discriminator (D) serving as a learning pair with the DUN super-resolution NW (G)).

In step S20, the mixing ratio search unit 151 determines whether all the mixing ratios of 0 to 0.1 have been applied. When it is determined in step S20 that not all the mixing ratios have been applied, the processing returns to step S17, and the processing of steps S17 to S19 described above is repeated. As a result, the image of the mixing processing result obtained by mixing the image of the subjective norm processing result and the image of the image quality enhancement processing result at all the mixing ratios of 0 to 0.1 is sequentially input to the discriminator 152, and the discrimination result is acquired for each mixing ratio.

When it is determined in step S20 that all the mixing ratios have been applied, the processing proceeds to step S21. In step S21, the control instruction data generation unit 146 selects the mixing ratio at which the value of the discrimination result of the discriminator 152 becomes minimum from the discrimination results acquired for each mixing ratio.

In step S22, it is determined whether the mixing ratio search processing has been executed for all the divided regions. When it is determined in step S22 that the processing has not been executed in all the divided regions, the processing returns to step S15, and the processing of steps S15 to S21 described above is repeated. As a result, for example, each region of the divided regions A1 to A12 in the image F1 of FIG. 6 is sequentially selected, and the mixing ratio at which the value of the discrimination result of the discriminator 152 is the minimum is selected for each region, and the control instruction data can be generated. When it is determined in step S22 that the processing has been executed in all the divided regions, the series of processing ends.

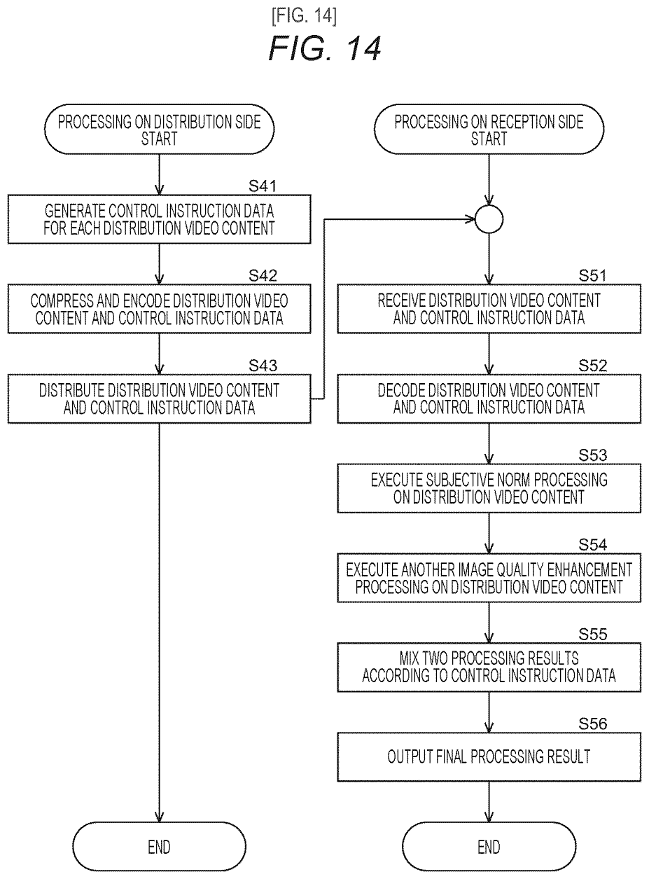

Next, a flow of image quality enhancement processing using the control instruction data will be described with reference to a flowchart of FIG. 14. In FIG. 14, the processing of the distribution-side system 101 is illustrated in steps S41 to S43, and the processing of the reception-side system 102 is illustrated in steps S51 to S56.

In step S41, the automatic generation processing unit 121 generates the control instruction data for each distribution video content. Here, the control instruction data generation processing described in the flowchart of FIG. 13 is executed, and the optimum mixing ratio is selected for each divided region of the decoded image for each distribution video content, and the control instruction data is generated.

In step S42, the encoding unit 122 compresses and encodes the distribution video content (original image) as the distribution target. Further, in step S43, the encoding unit 123 compresses and encodes the control instruction data corresponding to the distribution video content as the distribution target. In step S43, the transmission unit 124 distributes the compressed and encoded distribution video content and the control instruction data.

In step S51, the reception unit 131 receives the compressed and encoded distribution video content and the control instruction data distributed from the distribution-side system 101. In step S52, the decoding unit 132 decodes the compressed and encoded distribution video content. In addition, in step S52, the decoding unit 133 decodes the compression-encoded control instruction data.

In step S53, the subjective norm processing unit 134 executes the subjective norm processing on the decoded distribution video content (decoded image). In step S54, the image quality enhancement processing unit 135 executes another image quality enhancement processing (for example, error norm processing) on the decoded distribution video content (decoded image). In step S55, the mixing unit 136 mixes the image of the subjective norm processing result and the image of the image quality enhancement processing result according to the decoded control instruction data. In step S5, the mixing unit 136 outputs an image of a final processing result obtained by mixing the images of the two processing results.

As described above, according to the present disclosure, it is possible to enhance the image quality of an image accompanied by deterioration due to compression encoding at a lower cost in the case of using subjective norm processing in which the obtained processing result is high quality among DUN super-resolution. That is, the subjective norm processing is a generative model, and there is a case where a signal that does not actually exist (a video signal that does not exist before compression encoding of the distribution video content) is generated at a current technical level. Therefore, there is a possibility that quality degradation occurs when the processing result is used as it is. However, in the present disclosure, the control instruction data can be generated without taking time and human cost by using the discriminator (D) paired with the DUN super-resolution NW (G) used in the subjective norm processing at the time of learning.

Furthermore, according to the present disclosure, it is possible to restore an image with deterioration due to compression encoding to high image quality while maximally suppressing degradation in quality due to adverse effects of subjective norm processing. That is, although the subjective norm processing has a disadvantage while having very high image quality enhancement performance, further image quality enhancement can be realized by controlling the subjective norm processing by applying the present disclosure. Furthermore, according to the present disclosure, it is possible to automatically generate control instruction data for suppressing a decrease in quality due to subjective norm processing, and thus, it is possible to significantly reduce a cost (time, labor, and the like) of data creation as compared with a case where data is manually created by a person.

### Another Configuration Example 1

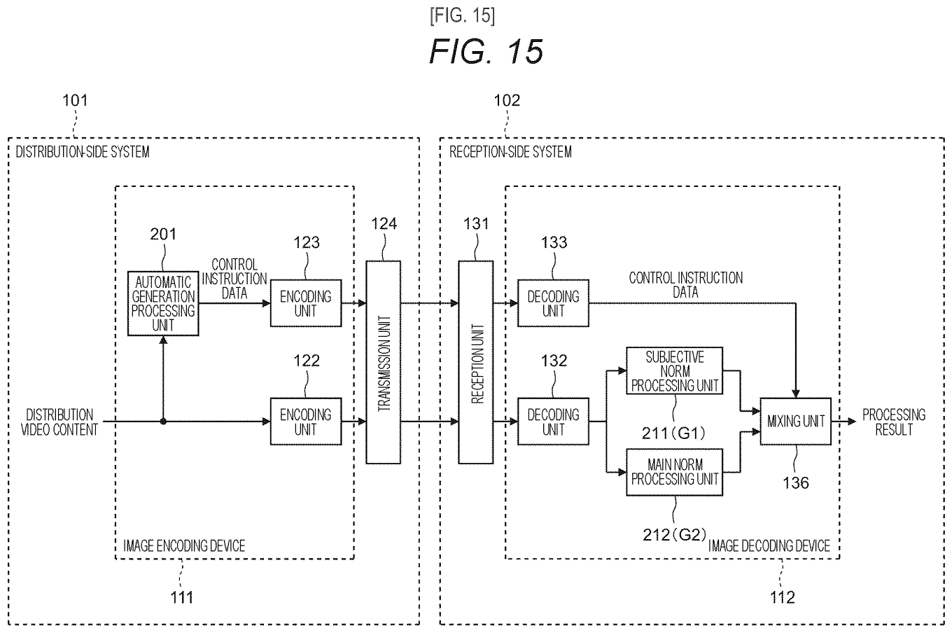

FIG. 15 is a block diagram illustrating another configuration example of a system to which the present disclosure is applied. In FIG. 15, portions corresponding to those in FIG. 7 are denoted by the same reference signs, and the description thereof will be omitted as appropriate. In FIG. 15, as the image quality enhancement processing, the reception-side system 102 does not execute the subjective norm processing and another image quality enhancement processing, but executes the first subjective norm processing and the second subjective norm processing.

The reception-side system 102 in FIG. 15 is different from the reception-side system 102 in FIG. 7 in that a subjective norm processing unit 211 and a subjective norm processing unit 212 are provided instead of the subjective norm processing unit 134 and the image quality enhancement processing unit 135. In addition, since it is necessary to change the generation method of the control instruction data in order to execute the first subjective norm processing and the second subjective norm processing, the distribution-side system 101 in FIG. 15 is provided with an automatic generation processing unit 201 instead of the automatic generation processing unit 121, as compared with the distribution-side system 101 in FIG. 7.

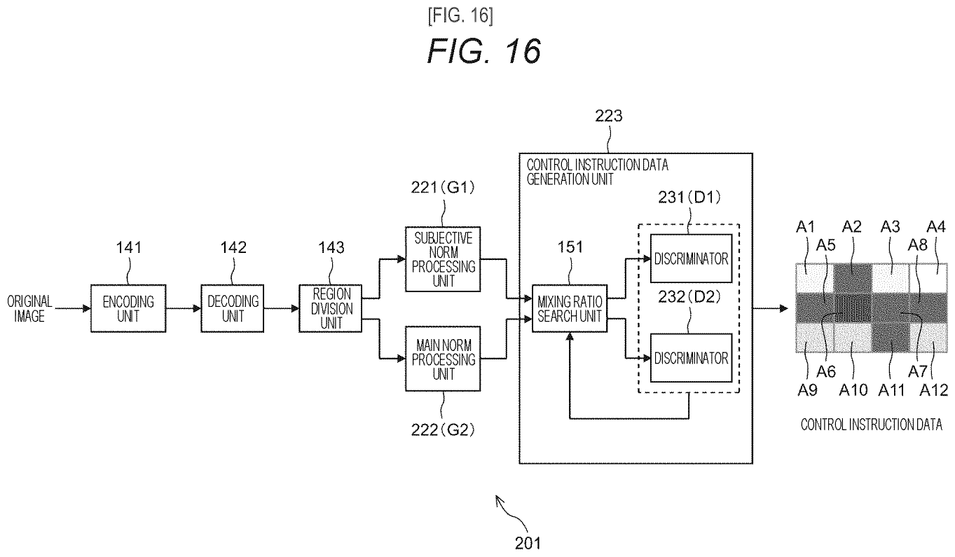

FIG. 16 is a diagram for explaining a method of generating the control instruction data by the automatic generation processing unit 201. In FIG. 16, portions corresponding to those in FIG. 11 are denoted by the same reference signs, and the description thereof will be omitted as appropriate. As compared with the automatic generation processing unit 121 in FIG. 11, the automatic generation processing unit 201 in FIG. 16 includes a subjective norm processing unit 221, a subjective norm processing unit 222, and a control instruction data generation unit 223 instead of the subjective norm processing unit 144, the image quality enhancement processing unit 145, and the control instruction data generation unit 146.

As described above with reference to FIGS. 9 and 10, in the GAN learning of the first subjective norm processing, learning of the discriminator (D1) and learning of the DNN super-resolution NW (G1) are repeated, so that the first learning pair of the DUN super-resolution NW (G1) and the discriminator (D1) is obtained after completion of learning of the DNN super-resolution NW (G1). Furthermore, in the GAN learning of the second subjective norm processing, by repeating the learning of the discriminator (D2) and the learning of the DUN super-resolution NW (G2), the second learning pair of the DUN super-resolution NW (G2) and the discriminator (D2) is obtained after the learning of the DUN super-resolution NW (G2) is completed. At the time of generating the control instruction data, among the first learning pair, the DNN super-resolution NW (G1) is used by the subjective norm processing unit 221, and the discriminator (D1) is used by the discriminator 231. In addition, among the second learning pair, the DNN super-resolution NW (G2) is used by the subjective norm processing unit 222, and the discriminator (D2) is used by the discriminator 232.

In the control instruction data generation unit 223, the mixing ratio search unit 151 sequentially mixes the image of the second subjective norm processing result with the image of the first subjective norm processing result until the value of the mixing ratio changes from 0 to 1.0, and inputs the mixture to the discriminator 231 and the discriminator 232. An average value of the discrimination results obtained by each of the discriminator 231 and the discriminator 232 is calculated, and a ratio at which the average value of the two discrimination results is minimized is obtained. That is, the smaller the values of the discrimination results of the discriminator 231 and the discriminator 232 are, the more it is determined that the image is an original image. Therefore, the optimum mixing ratio is set to a ratio at which the average value of the discrimination results is minimized. In FIG. 16, divided regions A1 to A12 of the control instruction data (control instruction map) correspond to the divided regions divided by the region division unit 143, and the mixing ratio of the two subjective norm processing automatically calculated for each of the divided regions A1 to A12 is represented by shading.

Note that the processing is basically similar to the processing illustrated in the flowchart of FIG. 13 except for the procedure of obtaining the average value of the two discriminators of the discriminator 231 and the discriminator 232. Furthermore, at the time of the image quality enhancement processing, it is sufficient that the DNN super-resolution NW (G1) of the first learning pair is used by the subjective norm processing unit 211 (FIG. 15), and the DNN super-resolution NW (G2) of the second learning pair is used by the subjective norm processing unit 212 (FIG. 15).

### Another Configuration Example 2

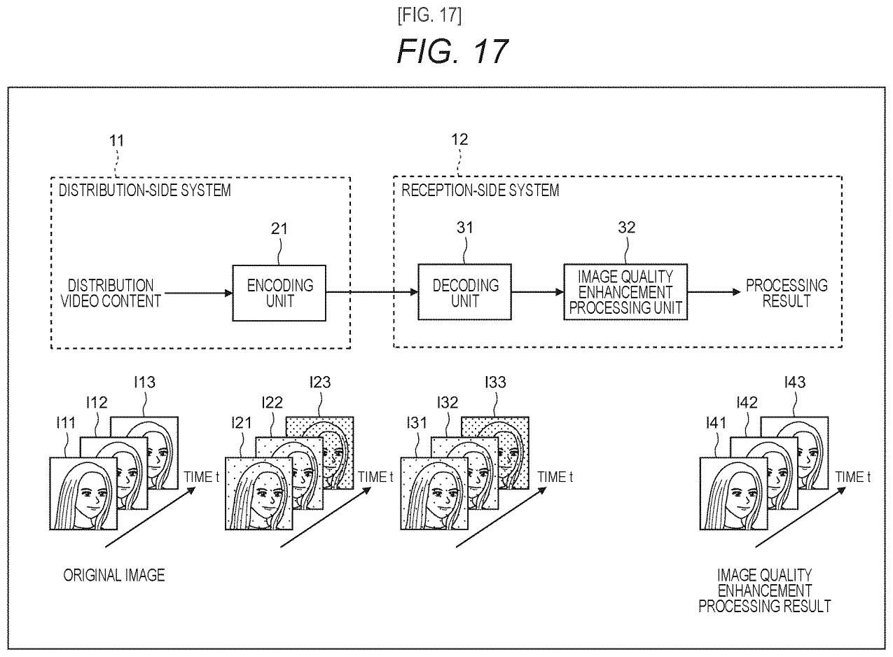

FIG. 17 is a diagram for explaining a basic configuration of image quality enhancement of the distribution video content when the bit rate fluctuates. In many distribution services, a bit rate of encoding of distribution video content may vary in a time direction for the following two reasons.

First, since there is an upper limit to the amount of data that can be distributed by the distribution-side system 11 at a time, when there are a large number of users using the reception-side system 12, the bit rate of the distribution video content to be distributed decreases. Conversely, when there are few users who use the reception-side system 12, the bit rate of the distribution video content can be increased.

Secondly, when the environment of data reception on the user side using the reception-side system 12 is good and a lot of data can be received, the distribution-side system 11 can distribute the distribution video content at a high bit rate, and the reception-side system 12 can receive the distribution video content distributed at a high bit rate. On the contrary, when the data reception environment on the user side is not good, the distribution video content is distributed and received at a low bit rate. For example, in the case of a fixed terminal such as a PC, the environment of data reception on the user side is the state of a communication line of the Internet, and in the case of a mobile terminal such as a smartphone, the environment of data reception on the user side is the state of a communication radio wave.

In FIG. 17, the image quality of the original images I11, I12, and I13 of the distribution video content is constant in the time direction. Further, due to the above-described reason, the bit rate of the distribution video content to be distributed varies with time. For example, the images I21 and I22 of the distribution video content distributed from the distribution-side system 11 have a high bit rate, but the image I23 distributed thereafter has a low bit rate. Alternatively, the images I31 and I32 of the distribution video content received by the reception-side system 12 have a high bit rate, but the image I33 of the distribution video content received thereafter has a low bit rate.

Here, a relationship in which the image quality is enhanced when the bit rate of encoding is high and the image quality is deteriorated when the bit rate of encoding is low is generally established, but there is an exception. For example, when the original image includes a complicated pattern or vigorous motion, the amount of data of compression encoding required to express the pattern or the vigorous motion increases. Therefore, even at the same bit rate, the image quality of the image decoded by the decoding unit 31 after compression encoding by the encoding unit 21 may vary depending on the pattern and motion of the original image. Further, in the image quality enhancement processing by the image quality enhancement processing unit 32, it is required to obtain an image (image I41, I42, or I43) as a result of the image quality enhancement processing in which the image quality is as close as possible to the original image without temporally varying the image quality with respect to the input image (image I31, I32, or I33) in which the image quality temporally varies. However, since the image quality varies even at the same bit rate, it is not sufficient to take measures by switching or mixing the image quality enhancement processing using the bit rate as an instruction value.

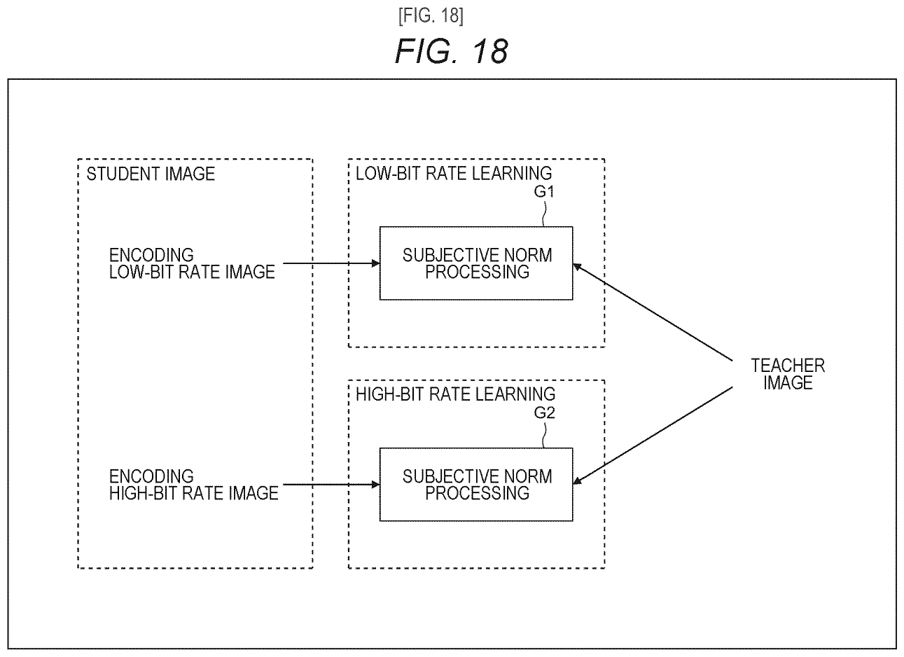

FIG. 18 is a diagram for explaining processing at the time of learning when the bit rate fluctuates. In FIG. 18, the encoded low-bit rate image is a student image encoded at a low bit rate, and the encoded high-bit rate image is a student image encoded at a high bit rate. At this time, the subjective norm processing (G1) learned (low-bit rate learning) using the encoded low-bit rate image and the teacher image as learning data has a strong effect of suppressing encoding noise, but fine patterns tend to be suppressed without being sharpened. That is, since there is a high possibility that the fine pattern in the student image at the time of learning is the encoding noise, it is difficult to distinguish whether the fine pattern is the encoding noise or the fine pattern included in the original image at the time of the image quality enhancement processing, and the fine pattern tends to be suppressed without sharpening.

Furthermore, as described above, even in the case of encoding at the same bit rate, the image quality after encoding and decoding varies depending on the fineness of the pattern of the original image and the complexity of the motion, and thus, the image quality of all the student images is not uniform even if the student images are encoded/decoded images of the same low bit rate. However, in the learning of the subjective norm processing, the processing performance of the learning result is determined by the average property of the image quality of the student image, and the encoded low-bit rate image has poor image quality on average and contains a lot of encoding noise. Therefore, learning to output the above-described processing result is performed.

Meanwhile, the subjective norm processing (G2) in which learning (high-bit rate learning) is performed using the encoded high-bit rate image and the teacher image as learning data has high performance of sharpening a fine pattern, but may erroneously emphasize encoding noise. Note that, in FIG. 18, the subjective norm processing (G1) and the subjective norm processing (G2) use DNN super-resolution NW (G1) and DUN super-resolution NW (G2) obtained by GAN learning of the subjective norm processing.

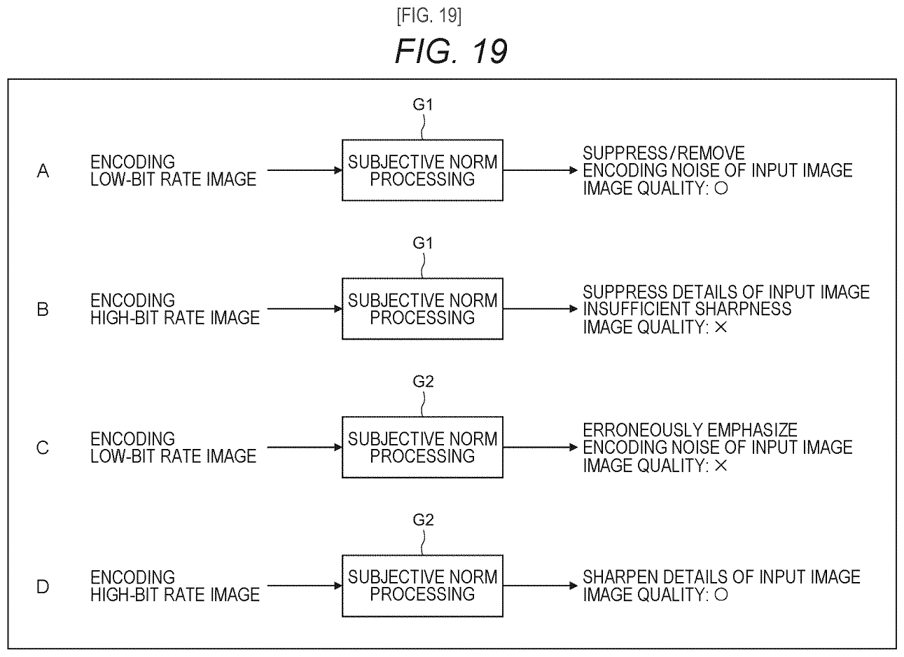

To summarize the above, the output of the subjective norm processing at the time of the image quality enhancement processing is as illustrated in FIG. 19. That is, when an encoded low-bit rate image is input to the subjective norm processing (G1), it is possible to suppress/remove encoding noise of the input image (A of FIG. 19). When an encoded high-bit rate image is input to the subjective norm processing (G1), details of the input image tend to be suppressed, and sharpness may be insufficient (B of FIG. 19). That is, the image quality becomes good when the encoded low-bit rate image is input to the subjective norm processing (G1) learned by the low-bit rate learning, but the image quality may deteriorate when the encoded high-bit rate image is input.

Furthermore, when the encoded low-bit rate image is input to the subjective norm processing (G2), there is a possibility that the encoding noise of the input image is erroneously emphasized (C of FIG. 19). When an encoded high-bit rate image is input to the subjective norm processing (G2), details of the input image can be sharpened (D of FIG. 19). That is, when an encoded high-bit rate image is input to the subjective norm processing (G2) learned by high-bit rate learning, the image quality is enhanced, but when an encoded low-bit rate image is input, the image quality may be deteriorated.

Therefore, it is possible to obtain a better processing result by holding both the subjective norm processing (G1) learned by the low-bit rate learning and the subjective norm processing (G2) learned by the high-bit rate learning and appropriately mixing (switching) the processing results of the subjective norm processing according to the image quality of the input image.

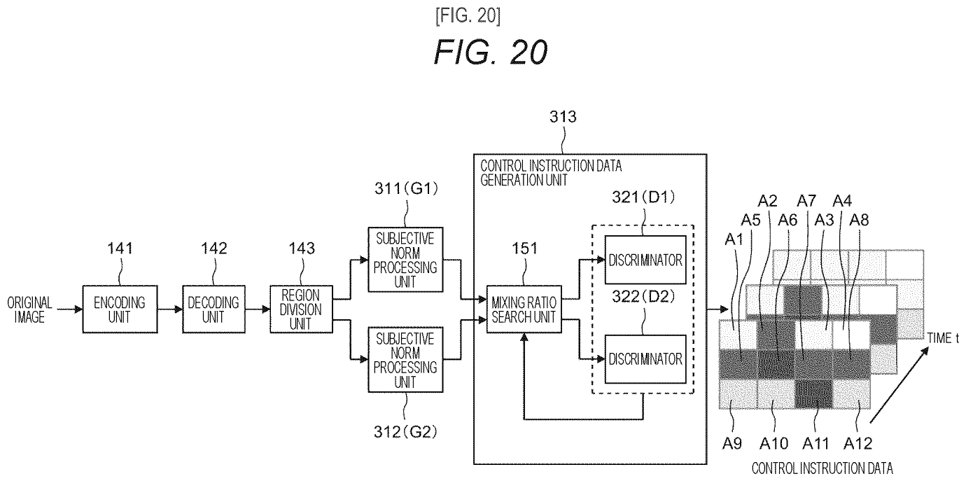

FIG. 20 is a diagram for explaining a method of generating control instruction data when the bit rate fluctuates. In FIG. 20, the compression encoding by the encoding unit 141 and the decoding by the decoding unit 142 are performed in a state where the bit rate at the time of distributing the distribution video content is simulated and temporally varied. The encoding unit 141 compresses and encodes the original image of the distribution video content, and supplies encoded data obtained as a result to the decoding unit 142. The decoding unit 142 decodes the encoded data, and supplies a decoded image of the distribution video content obtained as a result to the region division unit 143.

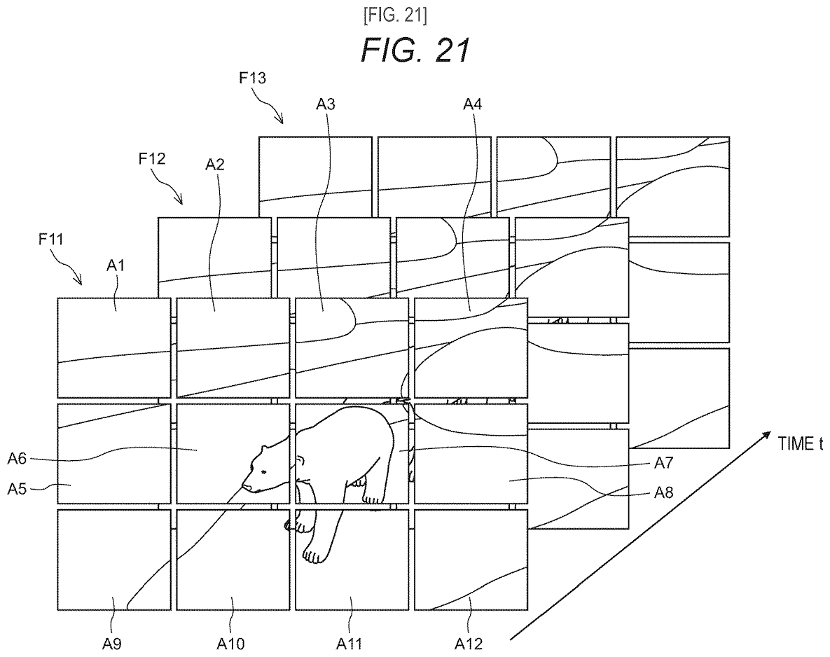

The region division unit 143 divides (the image frames of) the decoded image from the decoding unit 142 into predetermined regions, and supplies the divided decoded image to the subjective norm processing unit 311 and the subjective norm processing unit 312. Here, the region size is divided into region sizes that can be discriminated by a normal discriminator. Generally, the inputtable image size is often a rectangle. In this example, in order to facilitate the description, (the image frames of) the decoded images F11, F12, F13, . . . input in time series are sequentially divided into the regions A1 to A12 as illustrated in FIG. 21.

As described above with reference to FIGS. 9, 10, 18, and the like, in the GAN learning of the first subjective norm processing, the learning of the discriminator (D1) and the learning of the DUN super-resolution NW (G1) are repeated by the low-bit rate learning, so that the first learning pair of the DNN super-resolution NW (G1) and the discriminator (D1) is obtained after the learning of the DNN super-resolution NW (G1) is completed. Furthermore, in the GAN learning of the second subjective norm processing, by repeating the learning of the discriminator (D2) and the learning of the DUN super-resolution NW (G2) by the high-bit rate learning, the second learning pair of the DUN super-resolution NW (G2) and the discriminator (D2) is obtained after the learning of the DNN super-resolution NW (G2) is completed. In FIG. 20, among the first learning pair, the DNN super-resolution NW (G1) is used by the subjective norm processing unit 311, and the discriminator (D1) is used by the discriminator 321. In addition, among the second learning pair, the DNN super-resolution NW (G2) is used by the subjective norm processing unit 312, and the discriminator (D2) is used by the discriminator 322.

In the control instruction data generation unit 313, the mixing ratio search unit 151 sequentially mixes the image of the second subjective norm processing result with the image of the first subjective norm processing result until the value of the mixing ratio changes from 0 to 1.0, and inputs the mixture to the discriminator 321 and the discriminator 322. An average value of the discrimination results obtained by each of the discriminator 321 and the discriminator 322 is calculated, and a ratio at which the average value of the two discrimination results is minimized is obtained. That is, the smaller the values of the discrimination results of the discriminator 321 and the discriminator 322 are, the more it is determined that the image is an original image. Therefore, the optimum mixing ratio is set to a ratio at which the average value of the discrimination results is minimized. In FIG. 20, divided regions A1 to A12 of the control instruction data (control instruction map) correspond to the divided regions divided by the region division unit 143, and the mixing ratio of the two subjective norm processing automatically calculated for each of the divided regions A1 to A12 is represented by shading. Furthermore, since the bit rate at the time of distribution is simulated and temporally varied, the control instruction data indicating the ratio that changes in the time direction according to the bit rate variation is obtained by repeating the processing for each time T.

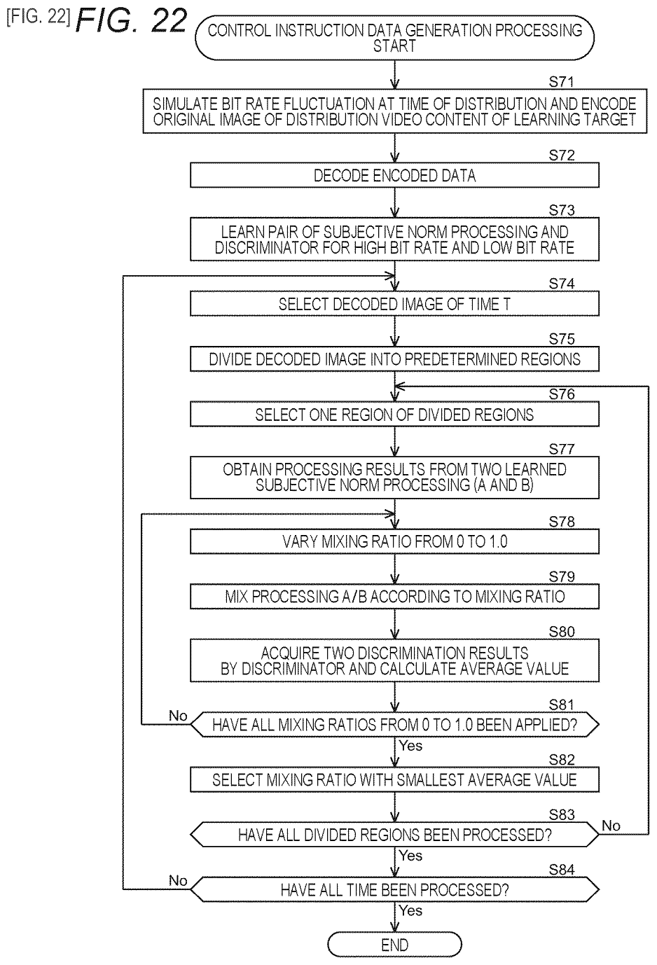

Next, a flow of control instruction data generation processing will be described with reference to a flowchart of FIG. 22. When the control instruction data generation processing is executed, the distribution video content to be learned is determined, and the determined distribution video content is processed.

First, the bit rate variation at the time of distribution is simulated for the distribution video content as the learning target, and compression encoding (S71) by the encoding unit 141 and decoding (S72) of the encoded data by the decoding unit 142 are performed. In step S71, the encoding unit 141 compresses and encodes the original image of the distribution video content to be learned to acquire encoded data. In step S72, the decoding unit 142 decodes the encoded data to acquire the decoded image of the distribution video content as the learning target.

In step S73, the pair of (the DNN super-resolution NW of) the subjective norm processing and the discriminator is learned at each of the low bit rate and the high bit rate. For example, in the low-bit rate learning, learning of the discriminator (D1) and learning of the DNN super-resolution NW (G1) are repeated, so that a first learning pair of the DNN super-resolution NW (G1) and the discriminator (D1) is obtained after completion of learning of the LDNN super-resolution NW (G1). Furthermore, in the high-bit rate learning, by repeating the learning of the discriminator (D2) and the learning of the DNN super-resolution NW (G2), a second learning pair of the DNN super-resolution NW (G2) and the discriminator (D2) is obtained after the learning of the DNN super-resolution NW (G2) is completed.

In step S74, the region division unit 143 selects the decoded image at time T from the decoded image of the distribution video content. In step S75, the region division unit 143 divides the selected decoded image into predetermined regions. For example, as illustrated in FIG. 21, when the decoded image F11 is selected, the decoded image F11 is divided into rectangular divided regions A1 to A12, so that one of the divided regions is selected (S76).

In step S77, the subjective norm processing unit 311 executes subjective norm processing (processing A) by the learned DNN super-resolution NW (G1) on the selected divided region to obtain a subjective norm processing result. Furthermore, in step S77, the subjective norm processing unit 312 executes subjective norm processing (processing B) by the learned DNN super-resolution NW (G2) on the selected divided region to obtain a subjective norm processing result.

In step S78, the mixing ratio search unit 151 changes and applies the value of the mixing ratio between 0 to 0.1. In step S79, the mixing ratio search unit 151 mixes the image of the processing result of the subjective norm processing (processing A) and the image of the processing result of the subjective norm processing (processing B) according to the applied mixing ratio. In step S80, the control instruction data generation unit 313 inputs the image of the mixing processing result obtained by mixing the images of the two subjective norm processing results according to the applied mixing ratio to the discriminator 321 and the discriminator 322, thereby acquiring two discrimination results by the discriminator 321 (the discriminator (D1) forming a learning pair with the DNN super-resolution NW (G)) and the discriminator 322 (the discriminator (D2) forming a learning pair with the DNN super-resolution NW (G2)) and calculating an average value.

In step S81, the mixing ratio search unit 151 determines whether all the mixing ratios of 0 to 0.1 have been applied. When it is determined in step S81 that not all the mixing ratios have been applied, the processing returns to step S78, and the processing of steps S78 to S80 described above is repeated. As a result, the mixing processing results obtained by mixing the two subjective norm processing results at all the mixing ratios of 0 to 0.1 are sequentially input to the two discriminators, and an average value of the two discrimination results is calculated for each mixing ratio.

When it is determined in step S81 that all the mixing ratios have been applied, the processing proceeds to step S82. In step S82, the control instruction data generation unit 313 selects the mixing ratio at which the average value of the two discrimination results is the smallest from the average values of the two discrimination results acquired for each mixing ratio.

In step S83, it is determined whether the mixing ratio search processing has been executed for all the divided regions. When it is determined in step S83 that the processing has not been executed in all the divided regions, the processing returns to step S7, and the processing of steps S76 to S82 described above is repeated. Thus, for example, the control instruction data can be generated by sequentially selecting the divided regions A1 to A12 in the decoded image F11 in FIG. 21 and selecting the mixing ratio at which the average value of the two discrimination results is minimized.

When it is determined in step S83 that the processing has been executed in all the divided regions, the processing proceeds to step S84. In step S84, it is determined whether execution has been completed at all times. When it is determined in step S84 that the processing has not been executed at all the times, the processing returns to step S74, and the processing of steps S74 to S83 described above is repeated. As a result, for example, after decoded image F11 in FIG. 21, each of divided regions A1 to A12 in decoded image F12 is sequentially selected, and the mixing ratio at which the average value of the two discrimination results becomes minimum is selected, so that the control instruction data can be generated. When it is determined in step S84 that the processing has been executed at all times, the series of processing ends.

The control instruction data generated as described above is distributed to the reception-side system 102 by the distribution-side system 101 together with the compressed and encoded distribution video content. Meanwhile, the reception-side system 102 performs the first subjective norm processing using the DNN super-resolution NW (G1) obtained by the low-bit rate learning and the second subjective norm processing using the DNN super-resolution NW (G2) obtained by the high-bit rate learning on the distribution video content received and decoded. Then, in accordance with the control instruction data distributed from the distribution-side system 101, the reception-side system 102 mixes the image of the first subjective norm processing result and the image of the second subjective norm processing result, and outputs an image of a final processing result obtained as a result. As described above, at the time of generating the control instruction data, the control instruction data is generated by simulating the bit rate variation at the time of distribution, so that it is possible to cope with a case where the bit rate of encoding varies at the time of the image quality enhancement processing.

### Another Configuration Example 3

The present disclosure can be applied to image quality enhancement of distribution video content, but can be applied to various contents. For example, the present technology can be applied to content such as movies, sports, drama, documentaries, animations, and games. Furthermore, various types of encoding codecs and encoding bit rates can be supported.

For example, when game content is distributed, a user interface (UI) on a game screen has many straight lines and characters, and it is required to clarify an outline and clean the line. Processing on other pictures and the like excluding the UI on the game screen generates a pattern, and the contour is not necessarily non-linear and clear. As described above, in the game screen, the image characteristics are completely different between the region of the UI and the other regions, and thus, it is possible to realize higher image quality by applying the optimum image quality enhancement processing to each region. Since the processing suitable for the region of the UI is relatively simple processing for sharpening the contour, it is desirable to apply the error norm processing and apply the subjective norm processing to the other regions.

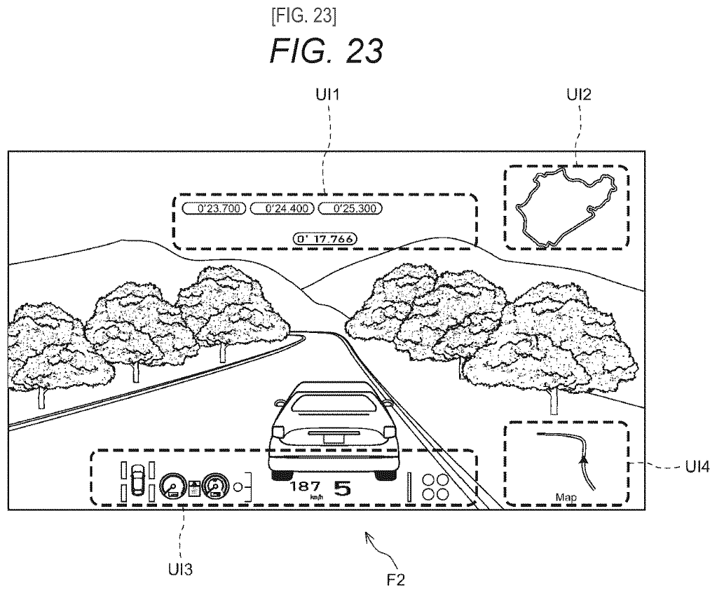

FIG. 23 is a diagram for explaining an example of a UI of a game content. In FIG. 23, the error norm processing is applied to the regions of UI1 to UI4 surrounded by broken lines on the game screen, and the subjective norm processing is applied to the regions other than UI1 to UI4. In this way, by changing the image quality enhancement processing for each region having different image characteristics, when content is presented to the user, it is possible to present the content with more appropriate image quality.

### Modification

In the description of FIG. 7 described above, the configuration in which the image encoding device 111 includes the automatic generation processing unit 121, the encoding unit 122, and the encoding unit 123 has been described, and the configuration in which the image decoding device 112 includes the decoding unit 132, the decoding unit 133, the subjective norm processing unit 134, the image quality enhancement processing unit 135, and the mixing unit 136 has been described. However, these configurations are merely examples, and other configurations may be adopted. For example, the image encoding device 111 may further include the transmission unit 124. The image decoding device 112 may further include the reception unit 131. The image decoding device 112 may include a display unit to display an image of a processing result by the mixing unit 136. Alternatively, the decoding unit 132, the subjective norm processing unit 134, the image quality enhancement processing unit 135, and the mixing unit 136 may be each configured as a separate device as a matter of course of being configured as one device. Note that, in the present disclosure, a system means a set of a plurality of components (devices, modules (parts), or the like), and it does not matter whether or not all the components are in the same housing.

In the description of FIG. 7 described above, the case where the subjective norm processing and the image quality enhancement processing (for example, error norm processing) different from the subjective norm processing are executed as the image quality enhancement processing in the reception-side system 102 has been described, but other processing (for example, processing without image quality enhancement) may be executed instead of the other image quality enhancement processing. For example, by directly inputting the image (decoded image) of the decoded distribution video content to the mixing unit 136, the mixing unit 136 can mix the image of the subjective norm processing result and the decoded image. At this time, when the control instruction data to be used by the mixing unit 135 (FIG. 7) is generated, instead of another image quality enhancement processing result by the image quality enhancement processing unit 145 (FIG. 11), it is sufficient that the divided decoded image from the region division unit 143 (FIG. 11) is directly input to the control instruction data generation unit 146 (FIG. 11) to generate the control instruction data. Note that, in the present disclosure, when the mixing ratio of the images of the subjective norm processing result is set to 0% (the mixing ratio of the images of another image quality enhancement processing result is set to 100%), the images are substantially replaced, and thus “mixing” also includes the meaning of “replacing (switching)”.

### <Configuration of Computer>

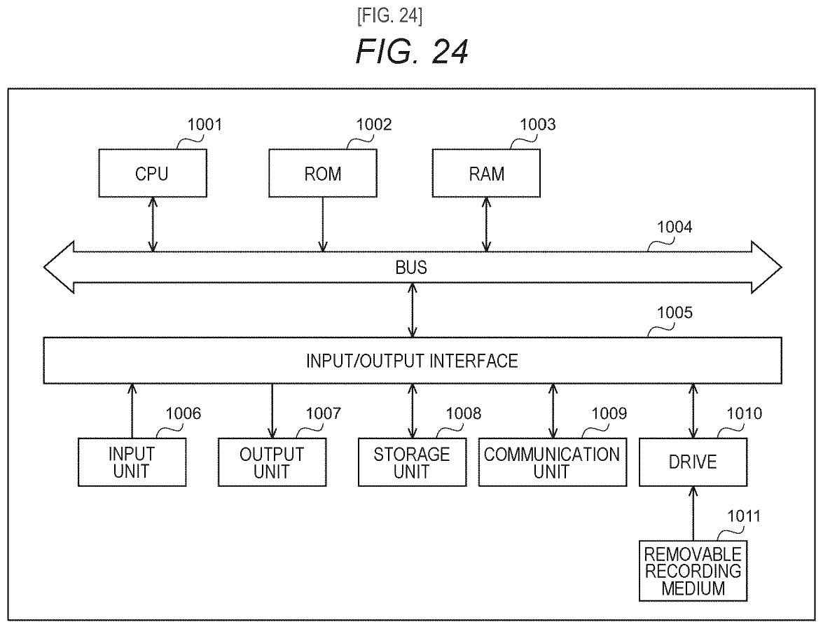

The above-described series of processing can be executed by hardware or software. When the series of processing is executed by software, a program constituting the software is installed in a computer. FIG. 24 is a block diagram illustrating a configuration example of hardware of a computer that executes the above-described series of processing by a program.

In the computer, a central processing unit (CPU) 1001, a read only memory (ROM) 1002, and a random access memory (PAM) 1003 are mutually connected by a bus 1004. An input/output interface 1005 is further connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone, and the like. The output unit 1007 includes a display, a speaker, and the like. The storage unit 100F includes a hard disk, a nonvolatile memory, and the like. The communication unit 1009 includes a network interface and the like. The drive 1010 drives a removable recording medium 1011 such as a semiconductor memory, a magnetic disk, an optical disk, or a magneto-optical disk.

In the computer configured as described above, the CPU 1001 loads a program recorded in the ROM 1002 or the storage unit 1008 into the PAM 1003 via the input/output interface 1005 and the bus 1004 and executes the program, whereby the above-described series of processing is performed.

The program executed by the computer (CPU 1001) can be provided by being recorded in the removable recording medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable recording medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Here, in the present specification, the processing performed by the computer according to the program is not necessarily performed in time series in the order described as the flowcharts. That is, the processing performed by the computer according to the program also includes processing executed in parallel or individually (for example, parallel processing or processing by an object). Furthermore, the program may be processed by one computer (processor) or may be processed in a distributed manner by a plurality of computers.

Note that the embodiments of the present disclosure are not limited to the above-described embodiments, and various modifications can be made without departing from the gist of the present disclosure. Furthermore, the effects described in the present specification are merely examples and are not limited, and other effects may be provided.

Furthermore, the present disclosure can have the following configurations.

(1)

An image encoding method including:
acquiring encoded data by compressing and encoding an original image;
acquiring a decoded image by decoding the encoded data;
generating a first processed image by applying a first learned image processing model and a second learned image processing model different from the first learned image processing model learned in advance by using a generator and a discriminator to the decoded image at a first ratio;
generating a second processed image by applying the first learned image processing model and the second learned image processing model to the decoded image at a second ratio different from the first ratio; and
generating control instruction data indicating an optimum ratio between the first learned image processing model and the second learned image processing model with respect to the original image on the basis of the discriminator, the first processed image, and the second processed image.
   (2)

The image encoding method according to (1), further including:
generating the first processed image by applying the first learned image processing model and the second learned image processing model to a first region and a second region of the decoded image at the first ratio; and
generating the second processed image by applying the first learned image processing model and the second learned image processing model to the first region and the second region at the second ratio.
   (3)

The image encoding method according to (1) or (2), in which
the first learned image processing model is an image processing model based on a peak signal-to-noise ratio (PSNR), and
the second learned image processing model is an image processing model based on a generative adversarial network (GAN).
   (4)

The image encoding method according to (2), further including
generating the control instruction data with the first ratio or the second ratio when a discrimination result becomes a minimum value as the optimum ratio when a minimum value of the discrimination result by the discriminator to which the first processed image and the second processed image are input is obtained.
   (5)

The image encoding method according to (4), further including
generating the control instruction data for each region including the first region and the second region by setting the first ratio or the second ratio when the discrimination result is a minimum value as the optimum ratio.
   (6)

The image encoding method according to (5), in which
the optimum ratio continuously changes at a boundary between the first region and the second region.
   (7)

The image encoding method according to (1) or (2), in which
each of the first learned image processing model and the second learned image processing model is a super-resolution processing model that generates an image with higher image quality than the decoded image.
   (8)

The image encoding method according to (1), in which
the original image is an image before compression encoding of content to be distributed.
   (9)

The image encoding method according to (1), in which
the first learned image processing model is an image processing model learned at a first bit rate by using a first generator and a first discriminator, and
the second learned image processing model is an image processing model learned at a second bit rate different from the first bit rate by using a second generator and a second discriminator, the image encoding method further including:
acquiring the encoded data and the decoded image by simulating a bit rate variation;
generating the first processed image by applying the first learned image processing model and the second learned image processing model to the decoded image at the first ratio;
generating the second processed image by applying the first learned image processing model and the second learned image processing model to the decoded image at the second ratio; and
generating the control instruction data on the basis of the first discriminator, the second discriminator, the first processed image, and the second processed image, the control instruction data indicating an optimum ratio between the first learned image processing model and the second learned image processing model with respect to the original image, the optimum ratio being a ratio that changes in a time direction according to the bit rate variation.
   (10)

An image encoding device including:
an encoding unit that acquires encoded data by compressing and encoding an original image;
a decoding unit that obtains a decoded image by decoding the encoded data; and
a generation unit that generates control instruction data indicating an optimum ratio between a first learned image processing model and a second learned image processing model different from the first learned image processing model learned in advance using a generator and a discriminator with respect to the original image,
in which
the generation unit is configured to:
generate a first processed image by applying the first learned image processing model and the second learned image processing model to the decoded image at a first ratio;
generate a second processed image by applying the first learned image processing model and the second learned image processing model to the decoded image at a second ratio different from the first ratio; and
generate the control instruction data on the basis of the discriminator, the first processed image, and the second processed image.
   (11)

An image decoding method including:
acquiring a decoded image by decoding encoded data obtained by compressing and encoding an original image;
generating a first generated image by applying a first learned image processing model to the decoded image;
generating a second generated image by applying a second learned image processing model different from the first learned image processing model learned in advance using a generator and a discriminator to the decoded image;
acquiring control instruction data indicating an optimum ratio between the first learned image processing model and the second learned image processing model with respect to the original image; and
mixing the first generated image and the second generated image on the basis of the control instruction data, in which
the optimum ratio is a ratio based on the discriminator, the first processed image, and the second processed image,
the first processed image is generated by applying the first learned image processing model and the second learned image processing model to the decoded image at a first ratio, and
the second processed image is generated by applying the first learned image processing model and the second learned image processing model to the decoded image at a second ratio different from the first ratio.
   (12)

The image decoding method according to (11), in which
the first processed image is generated by applying the first learned image processing model and the second learned image processing model to a first region and a second region of the decoded image at the first ratio, and
the second processed image is generated by applying the first learned image processing model and the second learned image processing model to the first region and the second region at the second ratio.
   (13)

The image decoding method according to (11) or (12), in which
the first learned image processing model is an image processing model based on a peak signal-to-noise ratio (PSNR), and
the second learned image processing model is an image processing model based on a generative adversarial network (GAN).
   (14)

The image decoding method according to (12), in which
when a minimum value of a discrimination result by the discriminator to which the first processed image and the second processed image are input is obtained, the control instruction data sets the first ratio or the second ratio when the discrimination result becomes a minimum value as the optimum ratio.
   (15)

The image decoding method according to (14), in which
the control instruction data sets the first ratio or the second ratio when the discrimination result is a minimum value as the optimum ratio for each region including the first region and the second region.
   (16)

The image decoding method according to (15), in which
the optimum ratio continuously changes at a boundary between the first region and the second region.
   (17)

The image decoding method according to (11) or (12), in which
each of the first learned image processing model and the second learned image processing model is a super-resolution processing model that generates an image with higher image quality than the decoded image.
   (18)

The image decoding method according to (11), in which
the original image is an image before compression encoding of content to be distributed.
   (19)

The image decoding method according to (18), in which
the optimum ratio changes in a time direction according to a bit rate variation at a time of distribution.
   (20)

An image decoding device including:
a decoding unit that acquires a decoded image by decoding encoded data obtained by compressing and encoding an original image;
a first processing unit that generates a first generated image by applying a first learned image processing model to the decoded image;
a second processing unit that generates a second generated image by applying a second learned image processing model different from the first learned image processing model learned in advance using a generator and a discriminator to the decoded image;
an acquisition unit that acquires control instruction data indicating an optimum ratio between the first learned image processing model and the second learned image processing model with respect to the original image; and
a mixing unit that mixes the first generated image and the second generated image on the basis of the control instruction data,
in which
the optimum ratio is a ratio based on the discriminator, the first processed image, and the second processed image,
the first processed image is generated by applying the first learned image processing model and the second learned image processing model to the decoded image at a first ratio, and
the second processed image is generated by applying the first learned image processing model and the second learned image processing model to the decoded image at a second ratio different from the first ratio.

### REFERENCE SIGNS LIST

101 Distribution-side system
102 Perception-side system
111 Image encoding device
112 Image decoding device
121 Automatic generation processing unit
122 Encoding unit
123 Encoding unit
124 Transmission unit
131 Reception unit
132 Decoding unit
133 Decoding unit
134 Subjective norm processing unit
135 Inage quality enhancement processing unit
136 Mixing unit
141 Encoding unit
142 Decoding unit
143 Region division unit
144 Subjective norm processing unit
145 Image quality enhancement processing unit
146 Control instruction data generation unit
151 Mixing ratio search unit
152 Discriminator
201 Automatic generation processing unit
211 Subjective norm processing unit
212 Subjective norm processing unit
221 Subjective norm processing unit
222 Subjective norm processing unit
223 Control instruction data generation unit
231 Discriminator
232 Discriminator
311 Subjective norm processing unit
312 Subjective norm processing unit
313 Control instruction data generation unit
321 Discriminator
322 Discriminator

1. An image encoding method comprising:
acquiring encoded data by compressing and encoding an original image;
acquiring a decoded image by decoding the encoded data;
generating a first processed image by applying a first learned image processing model and a second learned image processing model different from the first learned image processing model learned in advance by using a generator and a discriminator to the decoded image at a first ratio;
generating a second processed image by applying the first learned image processing model and the second learned image processing model to the decoded image at a second ratio different from the first ratio; and
generating control instruction data indicating an optimum ratio between the first learned image processing model and the second learned image processing model with respect to the original image on a basis of the discriminator, the first processed image, and the second processed image.

2. The image encoding method according to claim 1, further comprising:
generating the first processed image by applying the first learned image processing model and the second learned image processing model to a first region and a second region of the decoded image at the first ratio; and
generating the second processed image by applying the first learned image processing model and the second learned image processing model to the first region and the second region at the second ratio.

3. The image encoding method according to claim 2, wherein
the first learned image processing model is an image processing model based on a peak signal-to-noise ratio (PSNR), and
the second learned image processing model is an image processing model based on a generative adversarial network (GAN)).

4. The image encoding method according to claim 2, further comprising
generating the control instruction data with the first ratio or the second ratio when a discrimination result becomes a minimum value as the optimum ratio when a minimum value of the discrimination result by the discriminator to which the first processed image and the second processed image are input is obtained.

5. The image encoding method according to claim 4, further comprising
generating the control instruction data for each region including the first region and the second region by setting the first ratio or the second ratio when the discrimination result is a minimum value as the optimum ratio.

6. The image encoding method according to claim 5, wherein
the optimum ratio continuously changes at a boundary between the first region and the second region.

7. The image encoding method according to claim 2, wherein
each of the first learned image processing model and the second learned image processing model is a super-resolution processing model that generates an image with higher image quality than the decoded image.

8. The image encoding method according to claim 1, wherein
the original image is an image before compression encoding of content to be distributed.

9. The image encoding method according to claim 1, wherein
the first learned image processing model is an image processing model learned at a first bit rate by using a first generator and a first discriminator, and
the second learned image processing model is an image processing model learned at a second bit rate different from the first bit rate by using a second generator and a second discriminator, the image encoding method further comprising:
acquiring the encoded data and the decoded image by simulating a bit rate variation;
generating the first processed image by applying the first learned image processing model and the second learned image processing model to the decoded image at the first ratio;
generating the second processed image by applying the first learned image processing model and the second learned image processing model to the decoded image at the second ratio; and
generating the control instruction data on a basis of the first discriminator, the second discriminator, the first processed image, and the second processed image, the control instruction data indicating an optimum ratio between the first learned image processing model and the second learned image processing model with respect to the original image, the optimum ratio being a ratio that changes in a time direction according to the bit rate variation.

10. An image encoding device comprising:
an encoding unit that acquires encoded data by compressing and encoding an original image;
a decoding unit that obtains a decoded image by decoding the encoded data; and
a generation unit that generates control instruction data indicating an optimum ratio between a first learned image processing model and a second learned image processing model different from the first learned image processing model learned in advance using a generator and a discriminator with respect to the original image,
wherein
the generation unit is configured to:
generate a first processed image by applying the first learned image processing model and the second learned image processing model to the decoded image at a first ratio;
generate a second processed image by applying the first learned image processing model and the second learned image processing model to the decoded image at a second ratio different from the first ratio; and
generate the control instruction data on a basis of the discriminator, the first processed image, and the second processed image.

11. An image decoding method comprising:
acquiring a decoded image by decoding encoded data obtained by compressing and encoding an original image;
generating a first generated image by applying a first learned image processing model to the decoded image;
generating a second generated image by applying a second learned image processing model different from the first learned image processing model learned in advance using a generator and a discriminator to the decoded image;
acquiring control instruction data indicating an optimum ratio between the first learned image processing model and the second learned image processing model with respect to the original image; and
mixing the first generated image and the second generated image on a basis of the control instruction data, wherein
the optimum ratio is a ratio based on the discriminator, the first processed image, and the second processed image,
the first processed image is generated by applying the first learned image processing model and the second learned image processing model to the decoded image at a first ratio, and
the second processed image is generated by applying the first learned image processing model and the second learned image processing model to the decoded image at a second ratio different from the first ratio.

12. The image decoding method according to claim 11, wherein
the first processed image is generated by applying the first learned image processing model and the second learned image processing model to a first region and a second region of the decoded image at the first ratio, and
the second processed image is generated by applying the first learned image processing model and the second learned image processing model to the first region and the second region at the second ratio.

13. The image decoding method according to claim 12, wherein
the first learned image processing model is an image processing model based on a peak signal-to-noise ratio (PSNR), and
the second learned image processing model is an image processing model based on a generative adversarial network (GAN).

14. The image decoding method according to claim 12, wherein
when a minimum value of a discrimination result by the discriminator to which the first processed image and the second processed image are input is obtained, the control instruction data sets the first ratio or the second ratio when the discrimination result becomes a minimum value as the optimum ratio.

15. The image decoding method according to claim 14, wherein
the control instruction data sets the first ratio or the second ratio when the discrimination result is a minimum value as the optimum ratio for each region including the first region and the second region.

16. The image decoding method according to claim 15, wherein
the optimum ratio continuously changes at a boundary between the first region and the second region.

17. The image decoding method according to claim 12, wherein
each of the first learned image processing model and the second learned image processing model is a super-resolution processing model that generates an image with higher image quality than the decoded image.

18. The image decoding method according to claim 11, wherein
the original image is an image before compression encoding of content to be distributed.

19. The image decoding method according to claim 18, wherein
the optimum ratio changes in a time direction according to a bit rate variation at a time of distribution.

20. An image decoding device comprising:
a decoding unit that acquires a decoded image by decoding encoded data obtained by compressing and encoding an original image;
a first processing unit that generates a first generated image by applying a first learned image processing model to the decoded image;
a second processing unit that generates a second generated image by applying a second learned image processing model different from the first learned image processing model learned in advance using a generator and a discriminator to the decoded image;
an acquisition unit that acquires control instruction data indicating an optimum ratio between the first learned image processing model and the second learned image processing model with respect to the original image; and
a mixing unit that mixes the first generated image and the second generated image on a basis of the control instruction data,
wherein
the optimum ratio is a ratio based on the discriminator, the first processed image, and the second processed image,
the first processed image is generated by applying the first learned image processing model and the second learned image processing model to the decoded image at a first ratio, and
the second processed image is generated by applying the first learned image processing model and the second learned image processing model to the decoded image at a second ratio different from the first ratio.
